(19) United States
(12) Patent Application Publication
(10) Pub. No.: US 2003/0002471 A1
(43) Pub. Date: Jan. 2, 2003

(54) Method for estimating carrier-to-noise-plus-interference ratio (CNIR) for OFDM waveforms and the use thereof for diversity antenna branch selection

(76) Inventors: James A. Crawford, San Diego, CA (US); Long P. Huynh, San Diego, CA (US)

Correspondence Address: FITCH EVEN TABIN AND FLANNERY, 120 SOUTH LA SALLE STREET, SUITE 1600, CHICAGO, IL, 60603-3406, US

(21) Appl. No.: 09/994,519

(22) Filed: Nov. 26, 2001

Related U.S. Application Data
(63) Continuation-in-part of application No. 09/800,444, filed on Mar. 6, 2001.
(63) Continuation-in-part of application No. 09/800,231, filed on Mar. 6, 2001.

(51) Int. Cl. H04J 1/00

(52) U.S. Cl. 370/343; 370/480

(57) ABSTRACT

A scheme for estimating the carrier-to-noise-plus-interference ratio (CNIR) for Orthogonal Frequency-Division Multiplexing (OFDM) waveforms makes use of a physical waveform frame structure including a diversity selection portion. The diversity selection portion may be located at the end of a burst as a postamble and includes one or more OFDM symbols each having a frequency bin structure including both non-zero and zero OFDM frequency bin content. A first set of measurements are taken from an antenna branch on the non-zero OFDM frequency bins, and a second set of measurements are taken from the antenna branch on the zero OFDM frequency bins. An estimate for CNIR for at least one of the non-zero OFDM frequency bins and at least one of the zero OFDM frequency bins of the antenna branch is then computed using the first and second set of measurements.

### CROSS-REFERENCE TO RELATED APPLICATIONS

This application is a Continuation-In-Part (CIP) application of U.S. patent application Ser. No. 09/800,444, filed Mar. 6, 2001, entitled PROBING SCHEME FOR DIVERSITY ANTENNA BRANCH SELECTION, and U.S. patent application Ser. No. 09/800,231, filed Mar. 6, 2001, entitled METHOD AND APPARATUS FOR DIVERSITY ANTENNA BRANCH SELECTION, the full disclosures of which are hereby both fully incorporated into the present application by reference.

### BACKGROUND OF THE INVENTION

1. Field of the Invention

The present invention relates generally to radio frequency (RF) communications, and more specifically to diversity reception in RF communications.

2. Discussion of the Related Art

The market for home and office networking is developing at a phenomenal rate. A cost-effective, robust, high-performance wireless local-area network (WLAN) technology is needed for distributing multimedia information within the indoor environment. An example of one proposed solution that purports to address the performance requirements of the home market is the IEEE 802.11a standard, which operates in the 5-GHz UNII (unlicensed National Information Infrastructure) band and can achieve data rates as high as 54 Mbits/s, which is a significant improvement over other standards-based wireless technology. The 802.11a standard has some unique and distinct advantages over other wireless standards in that it uses a technology called Orthogonal Frequency-Division Multiplexing (OFDM) as opposed to spread spectrum. OFDM is a technology that is better suited for some of the problems associated with the indoor wireless environment, such as the phenomenon called “multipath.”

A multipath environment is created when radio frequency (RF) signals propagate over more than one path from the transmitter to the receiver. Alternate paths with different propagation times are created when the RF signal reflects from objects that are displaced from the direct path. In other words, multiple radio signals are received from reflections off walls, ceilings, floors, furniture, people and other objects. The direct and alternate path signals sum at the receiver antenna to cause constructive and destructive interference, which have peaks and nulls across the modulation spectrum. When the receiver antenna is positioned in a null, received signal strength drops and the communication channel is degraded or lost. The reflected signals may experience a change in polarization relative to the direct path signal. This multipath environment is typical of indoor and in-office WLANs.

An approach to addressing the multipath problem is to employ multiple receiver antenna elements in order to selectively receive a signal from more than one direction or from a slightly different position. This approach, known as “diversity”, is achieved when receiving signals at different points in space or receiving signals with different polarization. Diversity that is achieved by receiving signals at different points in space is known as spacial diversity, and diversity that is achieved by receiving signals with different polarization is known as polarization diversity. Other types of receive diversity include, but are not limited to, time diversity and frequency diversity. Performance is further enhanced by isolating the separate antennas.

Diversity reception is important for achieving good bit error rate (BER) performance over channels that exhibit substantial multipath like the indoor wireless channel. The objective of diversity reception is to make use of statistically independent signal streams to reduce the impact of severe multipath-related channel fading. Namely, each of L number of receiving antenna branches receives an independent fading version of the same information-bearing signal such that the probability that all the signal components will fade simultaneously is reduced considerably. The benefits of using receive diversity, as compared to no diversity, are dramatic. The complexity, however, of having L number of receivers for full L-branch diversity is rather expensive.

OFDM is a modulation method that, like all wireless transmission schemes, encodes data onto a radio frequency (RF) signal. Conventional single carrier transmission schemes encode data symbols onto one radio frequency. OFDM encodes data symbols concurrently onto multiple frequencies, or “tones.” This results in very efficient use of bandwidth and provides robust communications in the presence of noise, intentional or unintentional interference, and reflected signals that degrade radio communications.

OFDM technology breaks one high-speed data signal into tens or hundreds of lower speed signals, which are all transmitted in parallel. The data is divided across the available spectrum into a set of tones. Each tone is orthogonal (independent or unrelated) to all the other tones. This arrangement includes even the adjacent tones and, therefore, eliminates the need for guard bands between them. OFDM achieves spectral efficiency because guard bands are only required around a set of tones (at the edges of the occupied modulation bandwidth).

Because OFDM is made up of many narrowband tones, frequency selective fading (as a result of multipath propagation) degrades only a small portion of the signal and has little or no effect on the remainder of the frequency components. This makes the OFDM system highly tolerant to multipath propagation and narrowband interference. Nevertheless, such frequency-selective fading can be severe to the affected portion of the signal and can affect the OFDM sub-channels differently across the RF bandwidth involved.

Thus, there is a need for a method, apparatus and/or system that overcomes these and other disadvantages by providing affordable diversity reception and reducing the effects of frequency-selective fading in OFDM communications.

### SUMMARY OF THE INVENTION

The present invention advantageously addresses the needs above as well as other needs by providing a method for use in communicating an orthogonal frequency division multiplexing (OFDM) signal. The method includes the steps of: receiving a burst with a system having L antenna branches and n radio frequency (RF) receivers, wherein the burst includes a diversity selection portion comprising one or more OFDM symbols that each have a frequency bin structure that includes both non-zero and zero OFDM frequency bin content; taking a first set of measurements from a first of the L antenna branches on one or more of the non-zero OFDM frequency bins; taking a second set of measurements from the first of the L antenna branches on one or more of the zero OFDM frequency bins; and computing an estimate for carrier-to-noise-plus-interference ratio (CNIR) for at least one OFDM frequency bin of the first of the L antenna branches using the first and second set of measurements.

In another embodiment the invention can be characterized as a method for use in communicating an OFDM signal that includes the steps of: generating a burst having a preamble portion and a data portion; adding a diversity selection portion to the burst, wherein the diversity selection portion includes one or more OFDM symbols that each have a frequency bin structure that includes both non-zero and zero OFDM frequency bin content; and transmitting the burst including the diversity selection portion within a frame structure.

In another embodiment the invention can be characterized as a communication burst embodied in an OFDM signal and is transmitted according to a frame structure, the burst includes a preamble portion including a plurality of OFDM symbols, the preamble portion including a coarse frequency estimation portion, a data portion following the preamble portion and including a plurality of OFDM data symbols, and a diversity selection portion. The diversity selection portion comprises one or more antenna probing portions. The diversity selection portion occurs after the coarse frequency estimation portion of the preamble portion and each of the one or more antenna probing portions includes one or more OFDM symbols. In another embodiment, the invention can be characterized as a communication burst embodied in an orthogonal frequency division multiplexing (OFDM) signal and transmitted within a frame structure, the burst including a preamble portion including a plurality of OFDM symbols, a data portion following the preamble portion and including a plurality of OFDM data symbols and a diversity selection portion comprising one or more antenna branch probing portions, wherein each of the one or more antenna branch probing portions includes one or more OFDM symbols. The diversity selection portion is configured for diversity antenna branch selection at a receiver receiving the communication burst based upon bin-by-bin measurements of the one or more OFDM symbols of the diversity selection portion.

In another embodiment the invention can be characterized as a medium access control (MAC) frame format embodied in an orthogonal frequency division multiplexing (OFDM) signal, the frame format comprising one or more communication bursts occupying different time portions of the frame format. Each of the one or more communication bursts comprises a preamble portion including a plurality of OFDM symbols, the preamble portion including a coarse frequency estimation portion, a data portion following the preamble portion and including a plurality of OFDM data symbols, and a diversity selection portion comprising one or more antenna branch probing portions. The diversity selection portion occurs after the coarse frequency estimation portion of the preamble portion and each of the one or more antenna branch probing portions includes one or more OFDM symbols.

In another embodiment the invention can be characterized as a method of performing diversity reception in radio frequency (RF) communications, comprising the steps of: receiving a burst with a system having L antenna branches and n RF receivers, wherein L and n are variables and the burst includes a preamble portion, a data portion and a diversity selection portion, the diversity selection portion including one or more antenna branch probing portions, wherein each of the one or more antenna branch probing portions includes one or more OFDM symbols; and taking measurements from n of the L antenna branches during one of the antenna branch probing portions.

In another embodiment the invention can be characterized as a method, and means for performing the method, of performing diversity antenna selection, the method comprising the steps of: taking measurements from L different antenna branches n antenna branches at a time; and using the measurements to identify a group of n of the L different antenna branches that minimizes an approximate bit error probability of a subsequent signal that will eventually be constructed from sub-carriers that are each received by any one of the n antenna branches in the identified group of n antenna branches.

In another embodiment the invention can be characterized as a An apparatus that includes a diversity antenna selection module, wherein the diversity antenna selection module comprises: a first computation stage configured to compute an approximate bit error probability for each of K sub-carriers of an OFDM signal received for each of L different antenna branches n antenna branches at a time; and a second computation stage configured to process the approximate bit error probabilities to identify a group of n of the L different antenna branches that minimizes an approximate bit error probability of subsequent OFDM signals that will eventually be constructed from sub-carriers that are each received by any one of the n antenna branches in the identified group of n antenna branches.

A better understanding of the features and advantages of the present invention will be obtained by reference to the following detailed description of the invention and accompanying drawings which set forth an illustrative embodiment in which the principles of the invention are utilized.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a schematic diagram illustrating a system made in accordance with an embodiment of the present invention;

FIG. 2 is a timing diagram illustrating a conventional physical waveform;

FIG. 3 is a timing diagram illustrating a physical waveform made in accordance with another embodiment of the present invention;

FIG. 4 is a timing diagram illustrating a conventional OFDM communication burst transmitted within a conventional PHY-layer frame structure according to the IEEE 802.11a standard;

FIG. 5 is a timing diagram illustrating a preamble portion of a burst transmitted within a PHY-layer frame structure made in accordance with another embodiment of the present invention;

FIG. 6 is a timing diagram illustrating a preamble portion of a burst transmitted within a PHY-layer frame structure made in accordance with another embodiment of the present invention;

FIG. 7 is a timing diagram illustrating a burst transmitted within a PHY-layer frame structure made in accordance with another embodiment of the present invention;

FIG. 8 is a timing diagram illustrating a communication burst transmitted within a PHY-layer frame structure made in accordance with another embodiment of the present invention;

FIG. 9 is a timing diagram illustrating a communication burst transmitted within a PHY-layer frame structure made in accordance with another embodiment of the present invention;

FIG. 10 is a timing diagram illustrating a communication burst transmitted within a PHY-layer frame structure made in accordance with yet another embodiment of the present invention;

FIG. 11 illustrates the OFDM bin content for an OFDM short symbol according to the IEEE 802.11a standard to be used in a diversity selection portion of a PHY-layer frame in accordance with one embodiment of the invention;

FIG. 12 illustrates the OFDM bin content for an OFDM symbol to be used in a diversity selection portion of a PHY-layer frame in accordance with another embodiment of the invention;

FIG. 13 is a timing diagram illustrating a communication burst transmitted within a PHY-layer frame structure made in accordance with yet another embodiment of the present invention that is useful for estimating carrier-to-noise-plus-interference ratio (CNIR);

FIG. 14 is a flow chart illustrating a method of estimating CNIR of one antenna branch in accordance with an embodiment of the present invention;

FIG. 15 is an RF frequency spectrum diagram illustrating two different diversity branches;

FIG. 16 is a flowchart illustrating an exemplary antenna branch selection method in accordance with an embodiment of the present invention;

FIG. 17 is a block diagram illustrating an exemplary diversity antenna branch selection module made in accordance with an embodiment of the present invention;

FIGS. 18A and 18B are schematic diagrams illustrating an exemplary sub-carrier selection diversity module and diversity antenna branch selection module, respectively, made in accordance with embodiments of the present invention;

FIG. 19 is a schematic diagram illustrating in additional detail a portion of the diversity antenna branch selection module shown in FIG. 18B; and

FIGS. 20 and 21 are timing diagrams illustrating one embodiment of PHY-layer frame structure for a communication system including an access point and a plurality of remote terminals, and illustrating various communication bursts transmitted within the PHY-layer frame structure in accordance with another embodiment of the present invention.

Corresponding reference characters indicate corresponding components throughout the several views of the drawings.

### DETAILED DESCRIPTION OF THE INVENTION

The following description is not to be taken in a limiting sense, but is made merely for the purpose of describing the general principles of the invention. The scope of the invention should be determined with reference to the claims.

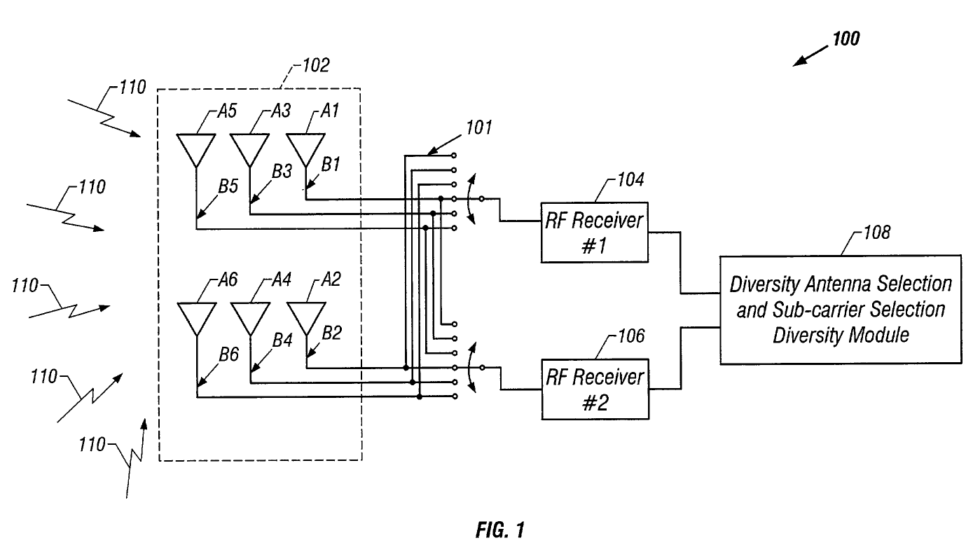

Referring to FIG. 1, there is illustrated a system 100 made in accordance with an embodiment of the present invention. The system 100 includes a diversity antenna 102, two radio-frequency (RF) receivers 104, 106, and a diversity antenna selection and sub-carrier selection diversity module 108. The system 100 can be manufactured for very low cost and is extremely well suited for wireless local area network (WLAN) applications operating at high frequencies, including the 5 to 6 GHz frequency band, in multipath environments where RF signals propagate over many different paths 110 from transmitter to receiver. Furthermore, the system 100 is well suited for use with multi-carrier modulation methods, such as Orthogonal Frequency Division Multiplexing (OFDM).

In this embodiment, the diversity antenna 102 includes six antenna branches B1, B2, B3, B4, B5, B6 connecting to six antenna elements A1, A2, A3, A4, A5, A6, respectively. The variable “L” is defined herein to represent the total number of antenna branches. Thus, L=6 for the illustrated diversity antenna 102. While the illustrated diversity antenna 102 includes six antenna branches B1, B2, B3, B4, B5, B6, it should be well understood that fewer or more than six antenna branches may be used in accordance with the present invention. In other words, L may be varied in accordance with the present invention.

By way of example, the diversity antenna 102 may comprise any of the antenna structures or antenna assemblies described in the following United States patent applications, which are hereby fully incorporated into the present application by reference: U.S. patent application Ser. No. 09/693,465, filed Oct. 19, 2000, entitled DIVERSITY ANTENNA STRUCTURE FOR WIRELESS COMMUNICATIONS, by inventor James A. Crawford; U.S. patent application Ser. No. 09/735,977, filed Dec. 13, 2000, entitled CARD-BASED DIVERSITY ANTENNA STRUCTURE FOR WIRELESS COMMUNICATIONS, by inventor James A. Crawford; and U.S. patent application Ser. No. 09/799,411, filed Mar. 5, 2001, entitled CONFORMAL BOX ANTENNA, by inventor James A. Crawford.

The two parallel RF receivers 104, 106, along with the diversity antenna selection and sub-carrier selection diversity module 108, are used for implementing a diversity combining technique in accordance with an embodiment of the present invention. Specifically, it was mentioned above that diversity is an effective technique for achieving good bit error rate (BER) performance over channels that exhibit substantial multipath and frequency selective fading, like the indoor wireless channel. There are several known methods of diversity combining. For coherent modulation with independent branch fading, maximal ratio combining (MRC) is known as an optimal linear combining technique, but the hardware complexity for MRC is directly proportional to the number of available combining paths. In other words, the complexity of full L-fold MRC is fairly high due to the need for L-RF receivers, particularly when more complex QAM signal constellations are considered. The complexity of having L receivers for any type of full L-branch diversity is rather expensive. On the other extreme, selection combining (SC) is a simple combining technique, in which the branch with the largest amplitude (or signal to noise ratio (SNR)) is selected for demodulation.

A compromise between MRC and SC called second order selection combining (SC2) combines two branch signals that improves the BER performance relative to that achievable with SC and requires less complex hardware than MRC. In accordance with SC2, the system 100 preferably performs diversity selection in two stages: first, two antenna branches are selected from among the L antenna braches (the “diversity antenna branch selection” stage); and second, each final OFDM sub-carrier is selected from the two receiving RF channels which have been coupled to the two selected antenna branches (the “sub-carrier selection” stage). The two antenna branches selected during the diversity antenna branch selection stage are preferably chosen to be the best branches from the total choice of L=6 branches B1, B2, B3, B4, B5, B6. By using this two stage scheme, only the two parallel RF receivers 104, 106 are needed as opposed to L-RF receivers for full L-fold MRC or another type of full L-branch diversity.

The use of two parallel RF receivers 104,106 is an ideal number of receivers in terms of hardware complexity and BER performance. It should be well understood, however, that more than two RF receivers, or only one RF receiver, may be used in accordance with some embodiments of the present invention. The variable “n” is defined herein to represent the number of available RF receivers. For example, if n=3, then three RF receivers are available and the system 100 preferably selects the three best branches from the total choice of L=6 branches during the diversity antenna branch selection stage. If n=1, then only one RF receiver is available and the system 100 preferably selects the one best branch from the total choice of L=6 branches. Note that in the case of n=1, the sub-carrier selection stage is not performed because each final OFDM sub-carrier must be selected from the one receiving RF channel. Thus, it should be well understood that the sub-carrier selection stage is itself an optional feature of the present invention. As an additional example, if L=4, then there are four antenna branches B1, B2, B3, B4 available and the system 100 can select the n best branches from the four available branches during the diversity antenna branch selection stage. In this example, if n=2, the system 100 selects the two best branches from the four available branches.

In accordance with an optional feature of the present invention, not all n of the available RF receivers must always be used. For example, if signal conditions are really good, software (or some other means) could choose to power-down one or more of the n available RF receivers and rely on less than n of the receivers to save power.

The function of selecting the two best branches (in the illustrated case of n=2) from the L=6 diversity branches B1, B2, B3, B4, B5, B6 available for examination is performed by the module 108. In general, the signal quality of each of the L different receive antenna elements A1, A2, A3, A4, A5, A6 is examined and the best two are selected. Specific methods that may be used for making this selection are described in detail below. The following discussion, however, first focuses on the timing of when antenna branch measurements (that will be used in the diversity antenna branch selection process) are made.

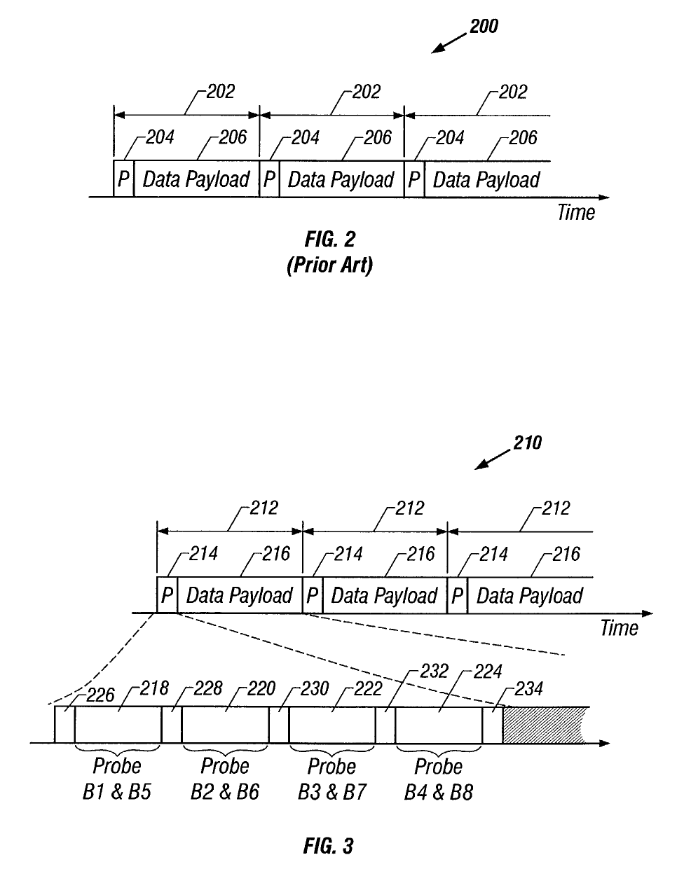

Antenna branch measurements are made during the reception of signals. Referring to FIG. 2, a conventional physical waveform 200 typically includes a series of PHY-layer frames 202, also known as a medium access control (MAC) frames. A communication burst made up of a plurality of transmit symbols (e.g., OFDM symbols) is transmitted within each frame. Each PHY-layer frame structure includes a preamble portion 204 and a data portion 206. The preamble portion 204 is typically used for signal detection, frequency offset estimation, timing synchronization and channel estimation. The data portion 206, of course, carries the data.

FIG. 3 illustrates a physical waveform 210 having PHY-layer frames 212 (or MAC frames 212) in accordance with one embodiment of the present invention. A communication burst made up of a plurality of transmit symbols is transmitted within each frame. Each PHY-layer frame 212 includes a preamble portion 214 and a data portion 216. With the PHY-layer frames 212, the signal quality of each of L=8 different receive antenna branches B1, B2, B3, B4, B5, B6, B7, B8 is measured, or probed or scored, during the preamble portion 214. The preamble portion 214 takes advantage of the two complete RF receivers 104,106 (FIG. 1) in that each probing sequence (or probing portion) is used to evaluate two antenna branches at a time. Specifically, antenna branches B1, B5 are probed during probing portion 218, antenna branches B2, B6 are probed during probing portion 220, antenna branches B3, B7 are probed during probing portion 222, and antenna branches B4, B8 are probed during probing portion 224. In this way the preamble portion 214 is used for probing the available diversity branches. Such antenna probing may also be referred to as antenna scoring.

The preamble portion 214 is preferably long enough, i.e., includes enough symbols, to permit all L antenna branches to be measured with sufficient signal-to-noise ratio for accurate results to be achieved. This may entail using multiple symbols for each antenna branch being so evaluated. Furthermore, one or more switching time intervals 226, 228, 230, 232, 234, or guard times 226, 228, 230, 232, 234, may be included to allow time for antenna branch switching. The switching time intervals 228, 230, 232 may be located between the antenna branch probing portions as illustrated. The switching time intervals 226, 234 may be located before the first antenna branch probing portion 218 and after the last antenna branch probing portion 224, respectively, as illustrated. The actual number of symbols used and the guard time for switching between branches may vary depending upon the specific application.

The antenna branch probing portions 218, 220, 222, 224 and the switching time intervals 226, 228, 230, 232, 234 form one exemplary version of what is referred to herein as a “diversity selection portion.” While this exemplary diversity selection portion is illustrated as being located in the preamble portion 214, the below discussion will make clear that the diversity selection portions described herein may be located anywhere in the PHY-layer frame (or MAC frame) in accordance with the present invention. Such diversity selection portions may also be referred to as “antenna scoring portions” or “antenna scoring waveforms”.

It is noted that the illustrated preamble portion 214 is designed for use with L=8 antenna branches but could just as easily be used for L=6 antenna branches by eliminating the final probing portion 224 used for probing branches B4, B8. Similarly, the illustrated preamble portion 214 could be used for L=4 antenna branches by eliminating the final two probing portions 222, 224, or for L=2 antenna branches by eliminating the final three probing portions 220, 222, 224. In a further similar manner, the illustrated preamble portion 214 could be used for probing more than eight antenna branches (i.e., L>8) by adding additional probing portions to the preamble portion 214.

It is also contemplated that the illustrated preamble portion 214 could be modified to take advantage of more than two available RF receivers, or only one available RF receiver. For example, if three RF receivers are available (n=3), three antenna branches could be simultaneously probed during each probing portion (or probing sequence), and if four RF receivers are available (n=4), four antenna branches could be simultaneously probed during each probing portion, etc. If only one RF receiver is available (n=1), then only one antenna branch would be probed during each probing portion. Thus, the diversity branch probing scheme of the present invention allows the cycling through of all L antenna branches n-branches at a time.

In accordance with an optional feature of the present invention, the diversity branch probing scheme (or antenna scoring scheme) of the present invention may be enabled or disabled depending upon signal quality. For example, if signal conditions are relatively good, the diversity branch probing scheme may be performed less frequently, and if signal conditions are really good, the diversity branch probing scheme may be disabled. Such enabling and disabling may be performed by software or some other means.

The PHY-layer frame structures for many different standards-based wireless technologies may be modified to include the diversity branch probing scheme of the present invention. For example, OFDM for WLAN applications has been standardized in the IEEE 802.11a standard (in the U.S.) and HiperLAN2 standard (in Europe), both of which are incorporated into the present application by reference.

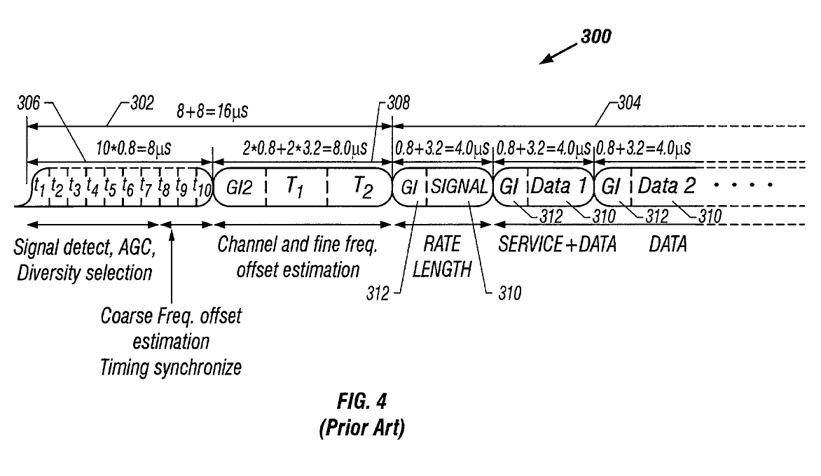

FIG. 4 illustrates the PHY-layer frame structure 300 for the IEEE 802.11a standard. A communication burst is transmitted within the frame 300. The frame 300 (also known as a PHY-layer frame 300 or a MAC frame 300) includes a preamble portion 302 and a data portion 304. The preamble portion 302 includes a short symbol portion 306 including short symbols and a long symbol portion 308 including long symbols. As shown in the figure, the short symbol portion 306 is used for signal detection, automatic gain control (AGC), diversity selection, coarse frequency offset estimation, and timing synchronization. The long symbol portion 308 is used for channel estimation and fine frequency offset estimation. The data portion 304 includes multiple symbols 310 (also referred to as OFDM symbols 310), each symbol 310 having a guard time interval 312 preceding it. This figure is the only place in the 802.11a standard that mentions diversity selection. It is believed that the present 802.11a standard provides inadequate time for effective diversity selection, if any at all. This is at least partly due to the difficulty of dealing with all of the data-bearing subcarriers used in the OFDM waveform before there has even been a coarse frequency estimate.

In modifying the IEEE 802.11a PHY-layer frame structure to include the diversity branch probing scheme of the present invention, the following analysis is taken into account. With respect to frame length, the frame length in 802.11a is variable, whereas the frame length used in HiperLAN2 is a fixed 2 msec frame. Short frames inherently lead to greater overhead loss, whereas long frames pose problems for both receive diversity systems as well as channel estimation methods.

One preferred maximum allowable frame length for some embodiments of the present invention is based upon the following RF-related analysis. In the indoor environment, it can be assumed that the multipath with be slow-changing with respect to time. At 5.35 GHz, a wavelength in free-space is 2.2 inches. If it is assumed that the maximum linear velocity of any object within the propagation volume is 20 feet per second or less (including doors shutting, venetian blinds vibrating, etc.), this velocity equates to 240 inches/second. If the maximum phase change between channel estimation/diversity operations is restricted to be 30 degrees in this present context, the maximum allowable time between updates is given by the following equation:

$$2 π \frac{{vT}_{f}}{λ} \leq {φ}_{max} \qquad ( 1 )$$

where v is the maximum linear velocity, T_{f} is the time between updates, and λ is the signal wavelength in free-space. For the conditions specified, T_{f}<0.76 msec. A frame size less than about 0.8 msec becomes prohibitive in terms of overhead. Therefore, a MAC frame size of 1.0 msec is ideal for supporting diversity and channel estimation processes in the PIIY-layer, in accordance with one embodiment of the present invention, because it can easily be doubled in length to match the HiperLAN2 frame structure.

In the HiperLAN2 context where the symbol rate is 250 kHz, 0.76 msec corresponds to 190 OFDM symbol intervals, and 1.0 msec corresponds to 250 OFDM symbol intervals. This provides plenty of symbol intervals such that some of them can be allocated to probe the channels in order to determine which 2-of-L antenna branches are the best to choose. As mentioned above, the preamble portion 214 should preferably include enough OFDM symbols to permit all L antenna branches to be measured with sufficient signal-to-noise ratio (SNR) for accurate results to be achieved. A MAC frame size of 1.0 msec leaves plenty of symbol intervals for this purpose.

If a finer degree of coherency is sought, equation (1) can be used to derive many different MAC frame sizes that may be used in alternative embodiments of the present invention. For example, according to equation (1), the maximum RF carrier phase change between algorithm updates will be less than or equal to 10 degrees if the diversity branches are re-examined at least once every 0.25 msec. In the HiperLAN2 context a MAC frame size of 0.25 msec corresponds to about 63 OFDM symbol intervals, which still allows some of the symbol intervals to be allocated for probing the antenna branches.

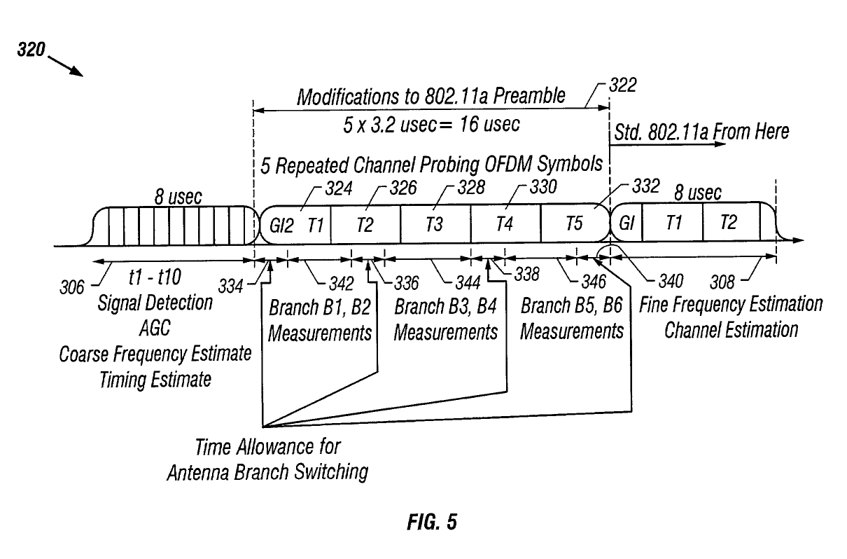

Turning to the preamble, the conventional 802.11a frame preamble is not sufficient to support the higher order diversity branch probing scheme of the present invention. Referring to FIG. 5, there is illustrated a diversity branch probing preamble burst 320 in accordance with one embodiment of the present invention. The diversity branch probing preamble burst 320 is transmitted within a MAC frame structure and includes a plurality of signals or transmit symbols (e.g., OFDM symbols). The diversity branch probing preamble burst 320 includes a diversity selection portion 322 inserted into the conventional 802.11a preamble frame format so that it supports the diversity branch probing scheme of the present invention. The diversity selection portion 322 is a modification or enhancement to the conventional 802.11a preamble frame structure or format.

While the conventional 802.11a preamble frame structure 300 consists of 16 μsec as shown in FIG. 4, the diversity branch probing preamble burst 320 shown in FIG. 5 includes a total of up to 32 μsec. The diversity selection portion 322, which supports 6-branch receive diversity, includes five repeated channel probing long OFDM symbols 324, 326, 328, 330, 332. Because each long OFDM symbol is 3.2 μsec, the diversity selection portion 322 adds (5)(3.2 μsec)=16 μsec to the 802.11a preamble.

This orchestration of channel probing is purposely done to simplify the receiver hardware needed to support 2-of-L receive diversity. Specifically, because there are two complete receiver paths 104, 106 (FIG. 1), each probing sequence can be used to evaluate two branches at a time. Sufficient time has been included in the diversity selection portion 322 for RF switching. Namely, four switching time intervals 334, 336, 338, 340 are included in the frame structure to allow time for antenna branch switching. This way, in order to probe the available diversity branches, antenna branches B1, B2 are switched on (i.e., coupled to their respective receivers) during switching time interval 334 and then measured during probing portion 342, antenna branches B3, B4 are switched on during switching time interval 336 and then measured during probing portion 344, and antenna branches B5, B6 are switched on during switching time interval 338 and then measured during probing portion 346. The selected pair of antennas are switched on during the final switching time interval 340.

Advantageously, the diversity branch probing preamble burst 320 does not require accurate symbol time alignment while measuring the different diversity paths, postponing accurate time alignment until the long-symbol intervals. This is because the signals used in the long symbols (T1-T5) are time periodic over any 3.2 μsec interval. Furthermore, the diversity branch probing preamble burst 320 should be long enough for supporting high quality channel estimation when it comes to the dense signal constellations like 64-QAM (or higher) and also provide enough latitude to support channel estimation if necessary.

Although the illustrated OFDM symbols 324, 326, 328, 330, 332 comprise long OFDM symbols, it should be well understood that OFDM symbols of a different length may be used in the diversity selection portion 322 in alternative embodiments of the present invention. For example, it is noted that OFDM short symbols, such as those in the short-symbol portion 306 of the preamble burst 320, only make use of every 4^{th} subcarrier, and therefore cannot be used to probe all of the data-bearing subcarriers used in the OFDM waveform. However, OFDM short symbols could be used in the diversity selection portion 322 to measure diversity branches if probing only every 4^{th} subcarrier were found to be satisfactory. In fact, as will be discussed below, another aspect of the present invention involves the use of probing signals having periodic unoccupied OFDM frequency bins (such as for example OFDM short-symbols) for estimating carrier-to-noise-plus-interference ratio (“CNIR” or “C/(N+I)”). This aspect may be referred to as a “CNIR-based” approach to diversity selection, while using OFDM symbols with all frequency bins being occupied is referred to as a “power-based” approach to diversity selection. Thus, while OFDM long symbols are advantageous for implementing power-based embodiments of the diversity antenna branch probing scheme of the present invention because they can be used to probe all of the data-bearing subcarriers used in the OFDM waveform, OFDM symbols having periodic unoccupied frequency bins (such as for example OFDM short-symbols) are also advantageous in CNIR-based embodiments for implementing both the diversity antenna branch probing scheme of the present invention and the CNIR estimation scheme of the present invention. While the use of OFDM long and short symbols is convenient due to their inclusion in the 802.11a standard, symbols of various other designs may be used, and it should be well understood that the diversity selection portions described herein may comprise short symbols or symbols of any other design, length or type for implementing an antenna probing sequence and/or CNIR estimation scheme in accordance with an embodiment of the present invention.

For simplicity, in power-based approaches, the signaling used for the OFDM symbol branch measurement probing portions can be the same as that used for the long symbol intervals T1 and T2 shown in the conventional 802.11a preamble 300 (FIG. 4). It should be well understood, however, that variations in the signaling may be used in accordance with the present invention. Furthermore, in power-based approaches, the noise level of each bin may be measured in order to determine the CNIR of each bin, for example, by transmitting a zero-power OFDM symbol from the transmitter and then measuring the noise received for each bin. However, this would require additional overhead and therefore, the CNIR-based approach is preferred.

It is noted that the illustrated diversity selection portion 322 is designed for use with L=6 antenna branches but could just as easily be used for more or fewer antenna branches by adding or eliminating one or more probing portions. For example, in an alternative embodiment of the present invention, only four repeated channel probing OFDM symbols T1, T2, T3, T4 are included to support four-branch receive diversity (L=4). This would allow enough time for two probing portions and associated switching time intervals. As an optional feature of the present invention, the PHY-layer hardware (discussed below) preferably includes the flexibility to be configured to (a) operate in the standard 802.11a mode, and (b) add a number of OFDM symbols to support L-branch diversity, such as for example, 2 (repeated) OFDM symbol intervals to support 4-branch diversity, 3 (repeated) OFDM symbol intervals to support 6-branch diversity, etc.

Table 1 provides a preamble overhead comparison of the standard 802.11a mode, an embodiment of the present invention supporting four-branch diversity, and an embodiment of the present invention supporting six-branch diversity.

TABLE 1
Preamble Overhead Comparison

| | | Time- | Time- |
|---|---|---|---|
| | Preamble | Overhead for | Overhead for |
| | Length, | 0.80 msec | 1.0 msec |
| Standard | μsec | Frame | Frame |
| 802.11a | 16 | 2.0% | 1.6% |
| Invention-4 | 28.8 | 3.6% | 2.88% |
| Branch | | | |
| Invention-6 | 32 | 4.0% | 3.2% |
| Branch | | | |

It is also contemplated that the illustrated diversity selection portion 322 of the preamble burst 320 could be used to take advantage of more than two available RF receivers, or only one available RF receiver. For example, if three RF receivers are available (n=3), three antenna branches could be simultaneously probed during each probing portion, and if four RF receivers are available (n=4), four antenna branches could be simultaneously probed during each probing portion, etc. If only one RF receiver is available, then only one antenna branch would be probed during each probing portion.

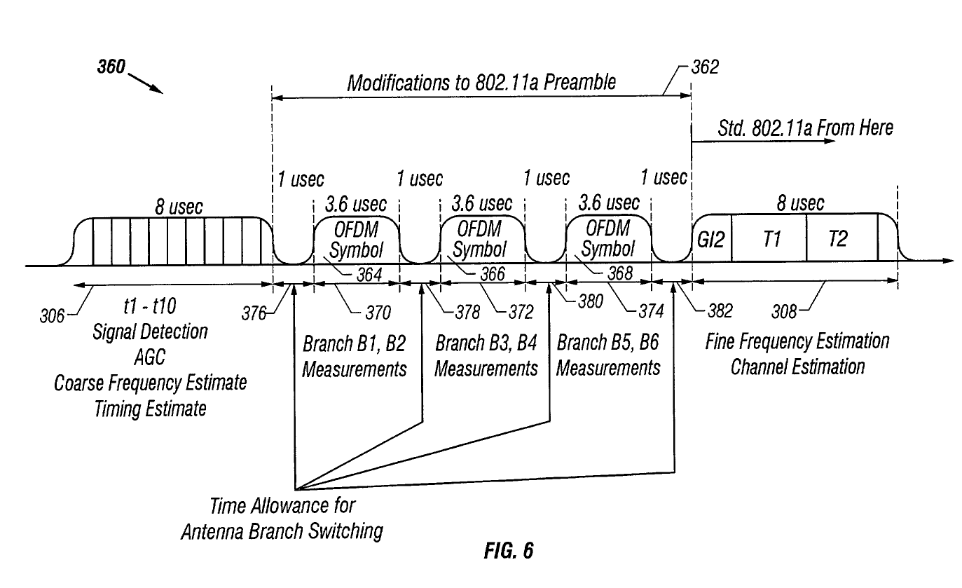

Referring to FIG. 6, there is illustrated a diversity branch probing preamble burst 360 in accordance with another embodiment of the present invention. The diversity branch probing preamble burst 360 is made up of a plurality of signals or symbols (e.g., OFDM symbols) and is transmitted within a PHY-layer or MAC frame structure. The diversity branch probing preamble burst 360 includes a diversity selection portion 362 inserted into the conventional 802.11a preamble frame structure so that it supports the diversity branch probing scheme of the present invention. Three 3.6 μsec OFDM symbols 364, 366, 368 are included which correspond to the three probing portions 370, 372, 374, respectively. Four 1.0 μsec switching time intervals 376, 378, 380, 382 are also included to allow time for antenna branch switching. Unlike the diversity branch probing preamble burst 320 (FIG. 5), however, the diversity branch probing preamble burst 360 is most effective when symbol time alignment is performed due to the 1.0 μsec switching time intervals 376, 378, 380, 382 being interleaved with the OFDM symbols 364, 366, 368.

The diversity selection portions 322 (FIG. 5), 362 (FIG. 6) described above are shown as being located in the preamble of a burst transmitted with a MAC frame structure. It should be well understood, however, that the diversity selection portions described herein may be located variously within the preamble burst and transmitted within various locations within a MAC frame structure in accordance with several embodiments of the present invention. The receiver must know the location of the diversity selection portion within a given burst and the location within the MAC frame a priori.

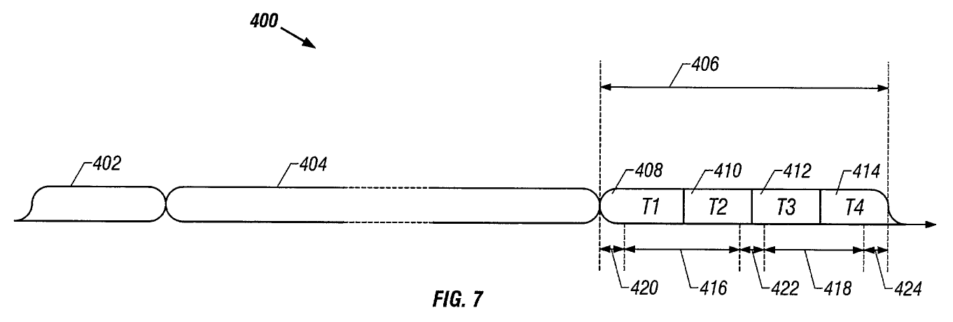

For example, referring to FIG. 7, there is illustrated a communication burst 400 (also referred to as burst 400) in accordance with another embodiment of the present invention that may be transmitted within a MAC frame structure. The burst 400 is comprised of a plurality of OFDM transmit symbols and preferably includes a preamble portion 402 and a data portion 404, which may comprise preamble and data portions in accordance with many different standards, such as for example the IEEE 802.11a standard or the HiperLAN2 standard. Following the data portion 404 is a diversity selection portion 406 used to implement the diversity branch probing scheme of the present invention. In this embodiment the diversity selection portion 406 can be referred to as a “postamble” of the communication burst 400.

The diversity selection portion 406 is similar to the diversity selection portion 322 (FIG. 5), except that four repeated channel probing OFDM long symbols 408, 410, 412, 414 are included instead of five. Because each OFDM symbol is 3.2 μsec, the diversity selection portion 406 adds (4)(3.2 μsec)=12.8 μsec to the frame structure 400. The four OFDM symbols 408, 410, 412, 414 support two probing portions 416, 418 and three antenna switching time intervals 420, 422, 424 such that if two RF receivers are used (n=2), 4-branch (L=4) receive diversity is supported. Namely, in order to probe the available diversity branches, antenna branches B1, B2 are switched on (i.e., coupled to their respective receivers) during switching time interval 420 and then measured during probing portion 416, and antenna branches B3, B4 are switched on during switching time interval 422 and then measured during probing portion 418. The selected pair of antennas are switched on during the final switching time interval 424 in order to receive subsequent bursts, e.g., transmitted in subsequent frames.

It is noted that in some embodiments, the switching interval 420 is not required. For example, in operation according to one embodiment, the signaling in a burst transmitted in a current frame is listened to by the two best antenna as determined by the measurements in the diversity selection portion 406 in the previous frame. For example, if antenna branches B2 and B3 were found (from the measurements in the diversity selection portion 406 of the previous frame) to be the best antenna pair, then antenna branches B2 and B3 are already switched on and are being used to listen to the data in the data portion 404 in the current burst received in the current frame. Thus, during probing portion 416, antenna branches B2 and B3 are measured (i.e., there was no need to switch to them since they were already switched on). Then, during switching time interval 422, antenna branches B1 and B4 are switched on and measured during probing portion 418. Therefore, switching time interval 420 is not required and may be omitted from the burst and its frame structure or included in the burst and its frame structure, but there is no switching that actually takes place. In some embodiments, it is noted that although no switching occurs during switching time interval 420, the interval is still present in order to maintain the proper timing for the FFTs.

Placing the diversity selection portion 406 after the data portion 404 means that the fine frequency estimation that occurs at the end of the preamble portion 402 is completed for the antenna branch probing process. In contrast, for the diversity selection portion 322 (FIG. 5) the antenna branch probing process is performed before the fine frequency estimation occurs. Since the channel estimate has already been done using the preamble T1-T2 region, coherent combining or averaging can also be conveniently done if this is postamble location is used. Thus, the positioning of the diversity selection portion 406 after the data portion 404 provides a very convenient location.

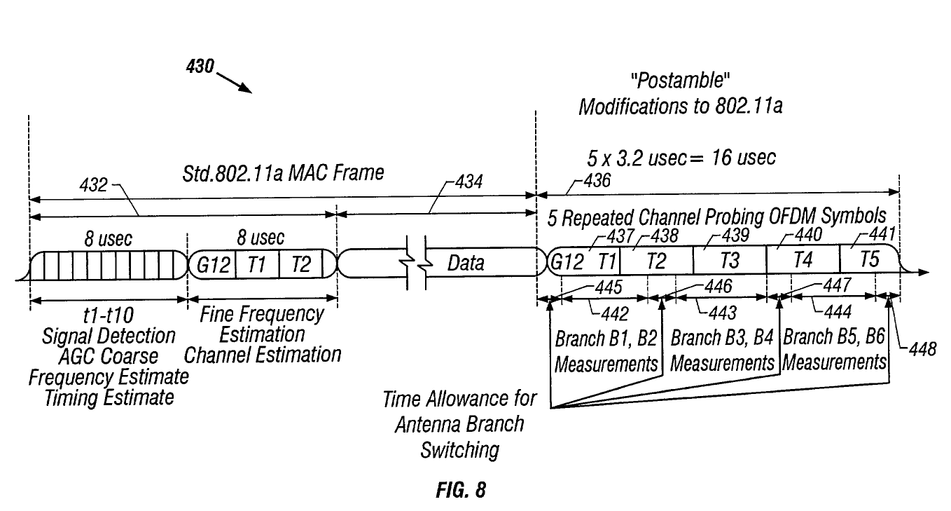

It is noted that the illustrated diversity selection portion 406 is designed for use with L=4 antenna branches but could just as easily be used for more or fewer antenna branches by adding or eliminating one or more probing portions. For example, FIG. 8 illustrates a communication burst 430 in accordance with another embodiment of the present invention. The burst 430 includes a plurality of symbols and is transmitted within a MAC frame structure. The burst 430 includes a preamble portion 432, a data portion 434, and a diversity selection portion 436 (or “postamble”) designed for use with L=6 antenna branches. Specifically, five repeated channel probing OFDM long symbols 437, 438, 439, 440, 441 are included in the diversity selection portion 436, which supports three probing portions 442, 443, 444 and four switching time intervals 445, 446, 447, 448, such that if two RF receivers are used (n=2), 6-branch (L=6) receive diversity is supported. It is also contemplated that the illustrated diversity selection portions 406 (FIG. 7), 436 (FIG. 8) could be used to take advantage of more than two available RF receivers, or only one available RF receiver.

Again, it is noted that in some embodiments, the switching time interval 445 is not required if the presently selected antenna branch pair that are receiving the data in the data portion 434 are measured during the probing portion 442, while probing portions 443 and 444 are used to measure the other antenna branches n (e.g., here, n=2) at a time.

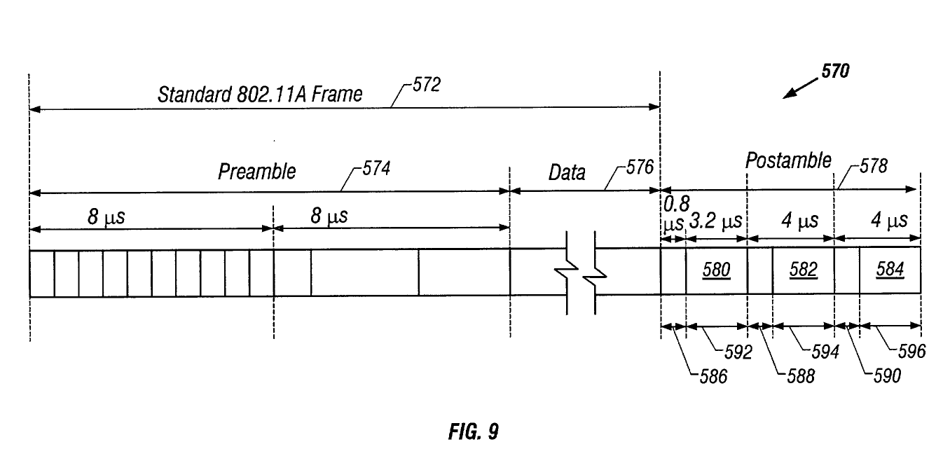

Referring next to FIG. 9, illustrates a frame structure 570 for transmitting a communication burst in accordance with another embodiment of the present invention. A communication burst including a plurality of various OFDM symbols is transmitted according to the frame structure 570. It is noted that in some embodiments, the frame structure 570 may be part of a larger MAC frame structure. The frame structure 570 includes a preamble portion 574, a data portion 576, and a diversity selection portion 578 (or “postamble”) designed for use with L=6 antenna branches. Specifically, after the completion of the data portion 576, three channel probing OFDM symbols 580, 582, 584 are included in the diversity selection portion 578. The diversity selection portion 578 supports three probing portions 592, 594, 596 and three switching time intervals 586, 588, 590 such that if two RF receivers are used (n=2), 6-branch (L=6) receive diversity is supported. It is also contemplated that the illustrated diversity selection portions 406 (FIG. 7), 436 (FIG. 8), 578 (FIG. 9) could be used to take advantage of more than two available RF receivers, or only one available RF receiver.

In operation, antenna branches B1, B2 are switched on (i.e., coupled to their respective receivers) during switching time interval 586 and then measured during probing portion 592, antenna branches B3, B4 are switched on during switching time interval 588 and then measured during probing portion 594, and antenna branches B5, B6 are switched on during switching time interval 590 and then measured during probing portion 596.

In this embodiment, each switching time interval and each corresponding probing portion are formatted to replicate the format of the data portion 576. For example, each switching time interval 586, 588, 590 are designed to be 0.8 μs in length and each probing portion is designed to be 3.2 μs in length; thus, mirroring the 4.0 μs length of the guard time interval (0.8 μs) and data symbol length (3.2 μs) for each symbol in the data portion of the IEEE 802.11a standard. Advantageously, this allows the same timing within the hardware to be used for the diversity selection portion 578 as used in the data portion 576. Furthermore, the frame structure appears similar to the standard IEEE 802.11a standard; however, the last portion is used for antenna diversity selection.

Furthermore, since the diversity selection portion 578 occurs after the completion of the data portion 576, the same advantages described with reference to FIGS. 7 and 8 are enjoyed. It is noted that the preamble portion 574 and the data portion 576 many be formatted according to many different standards, e.g., the IEEE 802.11a standard or the HiperLAN2 standard. In one embodiment, the preamble portion 574 and the data portion 576 represent the standard IEEE 802.11a frame structure 572. It is also understood that the diversity selection portion 578 may also be located at other positions within the frame structure 570, e.g., within the preamble portion 574, between the preamble portion 574 and the data portion 576, or within the data portion 576.

Again, switching time interval 586 is not required if the antenna pair measured (i.e., n=2) in probing portion 592 are the two (i.e., n) antenna branches already being used to receive the data in data portion 576. In this embodiment, to ensure the proper timing, the switching time interval 586 is included within the diversity selection portion, but no switching is necessary during the switching time interval. Thus, the appropriate switching occurs during switching time intervals 588 and 590 to ensure that the remaining antenna branches are measured during probing portions 582 and 584 n at a time, e.g., where n=2.

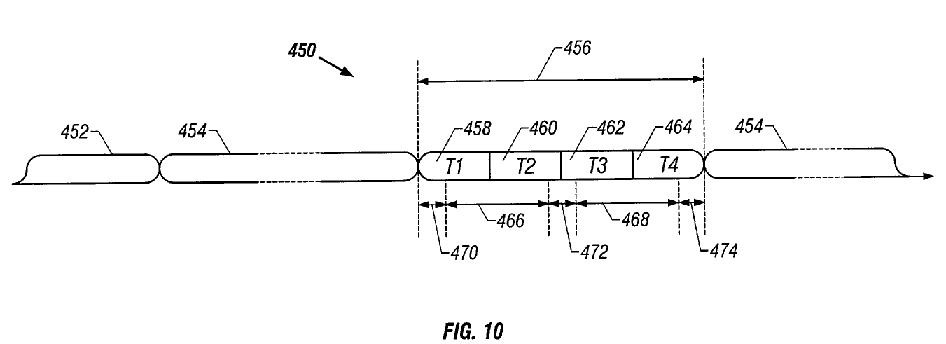

Referring to FIG. 10, there is illustrated a communication burst 450 to be transmitted within a MAC frame structure in accordance with yet another embodiment of the present invention. The burst 450 is made up of a plurality of various OFDM symbols segmented into a preamble portion 452 and a data portion 454, which again may comprise preamble and data portions in accordance with many different standards, such as for example the IEEE 802.11a standard or the HiperLAN2 standard. In this embodiment, however, a diversity selection portion 456 used to implement the diversity branch probing scheme of the present invention is inserted in the data portion 454.

Similar to the diversity selection portion 406 (FIG. 7), four repeated channel probing OFDM long symbols 458, 460, 462, 464 are included which support two probing portions 466, 468 and three switching time intervals 470, 472, 474. If two RF receivers are used (n=2), 4-branch (L=4) receive diversity is supported. But again, however, more or fewer antenna branches could be supported by adding or eliminating one or more probing portions. It is also noted that the diversity selection portion 456 of FIG. 10 may be replaced by the diversity selection portion 578 of FIG. 9. Again, as described above, no switching is required to occur during switching interval 470 and/or switching interval 470 may be removed from the frame structure.

Thus, the diversity branch probing scheme of the present invention is an exemplary way to accommodate the selection diversity methodology that is discussed below. Given the hardware capability to process a predetermined number of complete RF channels in parallel (such as two RF channels as shown in FIG. 1), the diversity branch probing scheme of the present invention provides an efficient means for considering a large number of antenna branches from which the predetermined number of branches (e.g., two) are retained for actual processing. In other words, the diversity branch probing scheme of the present invention allows the cycling through of all L antenna branches n-branches at a time.

As mentioned above, OFDM symbols of a different design, length or type may be used in the diversity selection portions 322 (FIG. 5), 362 (FIG. 6), 406 (FIG. 7), 436 (FIG. 8), 578 (FIG. 9), and 456 (FIG. 10) for communication bursts transmitted and received in the communication system. In fact, in accordance with another embodiment of the present invention, it has been found that use of a probing signal that has periodic unoccupied OFDM frequency bins is advantageous for estimating carrier-to-noise-plus-interference ratio (“CNIR” or “C/(N+I)”) at each OFDM frequency bin across the modulation bandwidth. CNIR_{k,l} is defined as the ratio of the received carrier power to the noise plus interference power for the k^{th} frequency bin using the l^{th} antenna and is an indicator of how well an antenna branch will perform. According to some embodiments, the determination of CNIR_{k,l} for every OFDM frequency bin is important in the context of diversity antenna operations as well as for use with erasure declaration pertaining to forward error correction (FEC) methods and other carrier-to-noise ratio (“CNR” or “C/N”) sensitive processes.

Determination of CNIR_{k,l} for the OFDM waveform instance can be difficult using conventional methods because the signal time samples obey an almost perfect Gaussian probability distribution function, thereby being very difficult to distinguish from normal additive Gaussian channel noise. Most conventional signal-to-noise ratio (SNR) estimation methods employ techniques that measure the similarity between a received signal's statistics and the Gaussian statistics expected for a noise-only signal. Such conventional methods are therefore very ineffective for use with OFDM waveforms given their Gaussian-like characteristics.

The present invention uses some of the antenna probing techniques described above for overcoming the difficulties of estimating CNIRs for the frequency bins of an OFDM waveform. As was described above, additional “antenna probing” signals can be conveniently added to a signaling waveform to permit accurate “antenna scoring,” thereby permitting the best n-of-L antenna branches to be chosen dynamically based upon a metric indicative of the underlying bit error rate (BER) or symbol error rate (SER).

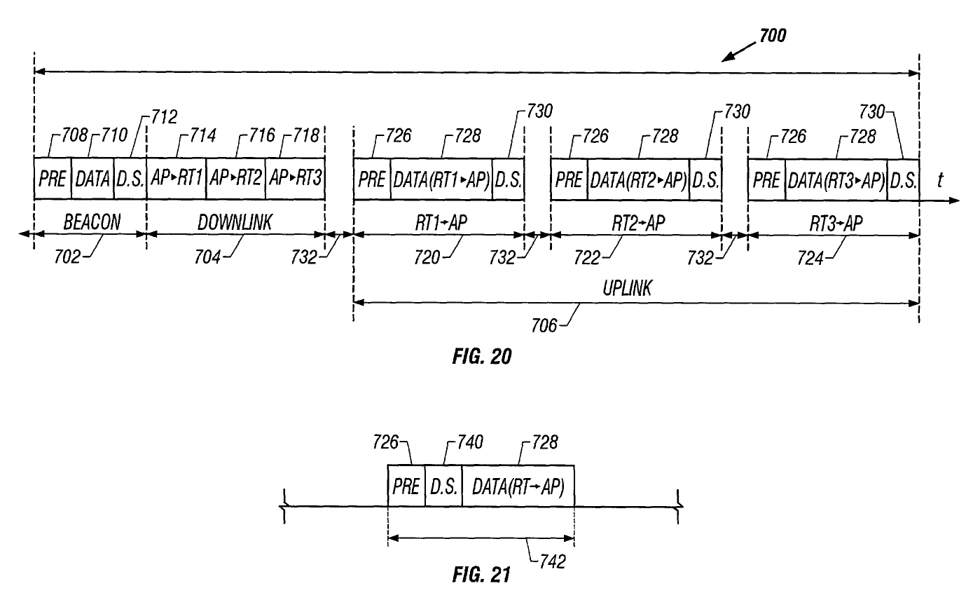

In the embodiments of the antenna probing/scoring technique that are illustrated in FIGS. 7, 8 and 9, the additional waveform attributes are added at the end of the burst, i.e., in a “postamble” of the burst that is transmitted within a MAC frame, for example. In other words, the additional waveform attributes may be added at the end of the downlink burst in the case of the Access Point (AP) terminal, or at the end of a user's uplink burst in the case of a Remote Terminal (RT). This is further illustrated with reference to FIGS. 20 and 21 below. There are several advantages to locating the diversity selection portion in the postamble rather than the preamble or elsewhere. One advantage is that the reception of the data portion is unaffected by the switching of antenna pairs since such switching occurs after reception of the data. Also, the preamble and data portion specified by the appropriate standard (e.g., IEEE 802.11a or HiperLAN2) may be left unaltered. Another advantage is that the processing hardware can read the beacon information (immediately following the IEEE 802.11a preamble or HiperLAN2 preamble) and determine if a postamble is present in the received burst. Furthermore, since such a postamble comes after the long symbols (T1/T2), coherent combining can be performed on the measurements of the postambles since the carrier phase and frequency are known after listening and tracking the previous portions of the signal frame.

As described above, the channel probing OFDM symbols appearing at the end of the transmission burst in FIGS. 7 and 8 may be standard “long symbols” as are used for the T1 and T2 portions of the standard IEEE 802.11a/HiperLAN2 preamble. Several advantages of using long symbols include that (a) the waveform will already be available, (b) it permits easy “scoring” of each OFDM bin, and (c) long symbols were purposely designed to have low peak-to-average power ratio (PAPR). Since the long symbols have signal energy in every data-bearing subcarrier however, the average noise level must be determined using any known technique to estimate the carrier to noise ratio for each frequency bin. Therefore, standard long symbols are preferably not used for the CNIR estimation aspect of the present invention. One technique to measure the average or bin-by-bin noise level if long symbols were to be used for the CNIR-based approach would be to intentionally send no signaling for a short period of time and measure the noise received on each frequency bin.

The CNIR estimation aspect of one embodiment of the present invention utilizes postamble OFDM symbols of a burst in a PHY-layer or MAC frame to (1) perform the previously described antenna scoring and also (2) provide an easy means to measure the prevailing frequency bin CNIRs. Namely, in some embodiments, the present invention estimates the CNIRs for each frequency bin by making use of a postamble diversity selection portion (e.g. diversity selection portions 406, 436, 578) comprising OFDM symbols that have a frequency bin structure that includes both non-zero as well as zero frequency bin content. This permits the carrier+noise+interference power to be measured in all of the (a priori known) non-zero frequency bins, and the noise+interference power to be measured in all of the zero bin locations.

Because only a fraction of the frequency bins are transmitted with non-zero power levels, more signal power could optionally be channeled to the non-zero frequency bins thereby delivering a lower variance estimate for the carrier+noise+interference quantity. This assumes that the transmitter output power level is kept constant relative to the mean power level of the adjacent data burst. Furthermore, this is not a necessary requirement for the CNIR estimation method of the present invention to work.

In one embodiment of the present invention, the already available “short-symbols” from the IEEE 802.11a/HiperLAN2 preamble are used for the postamble diversity selection portions 406, 436 of the waveforms shown in FIGS. 7 and 8. It is advantageous to use the short-symbols because they are already available and because they already contain an OFDM frequency bin structure that has some non-zero entries (every 4^{th} frequency bin is non-zero) as well as zero-entries (all other bins). Furthermore, the short-symbol waveform has a very low PAPR by design.

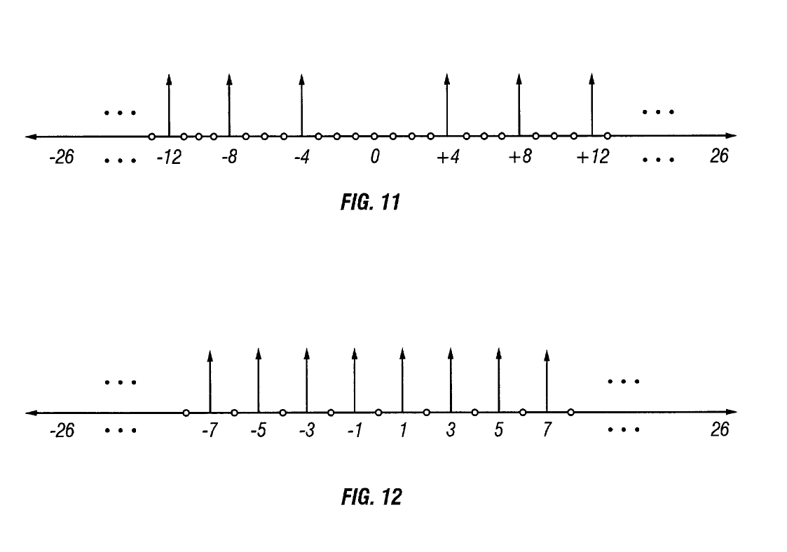

The contents of the short-symbol is immediately available from the IEEE 802.11a specification (slightly different for the HiperLAN2 specification). FIG. 11 illustrates the bin content versus OFDM bin number for an OFDM short symbol according to the IEEE 802.11a preamble. As illustrated, other than bin “0”, every fourth bin has non-zero contents (i.e., bins −24, −20, −16, −12, −8, −4, +4, +12, +16, +20 and +24), with all other bins transmitted with zero contents. Thus, there are twelve bins with non-zero content.

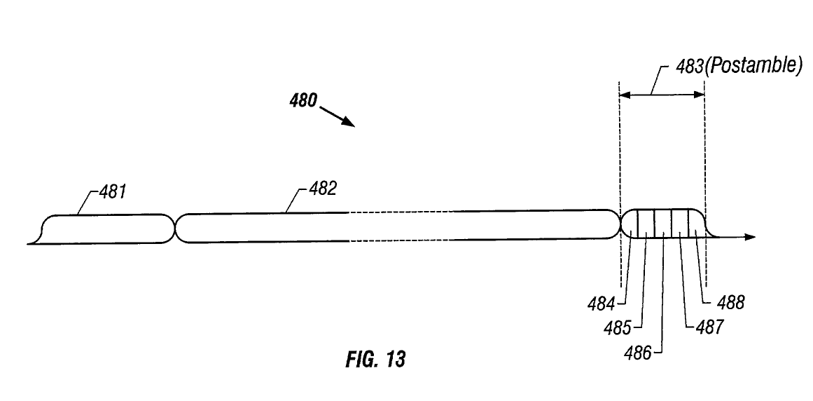

FIG. 12 illustrates another embodiment of the OFDM bin content versus OFDM bin number for an OFDM symbol to be used in a probing portions of the diversity selection portion of a PHY-layer frame in accordance with the CNIR estimation aspect of the present invention. In this embodiment, the OFDM symbol includes alternating non-zero bin content and zero bin content.

FIG. 13 illustrates a communication burst 480 transmitted within a MAC frame structure in accordance with an embodiment of the present invention. The burst 480 is made up of a plurality of various OFDM symbols segmented into a preamble portion 481, a data portion 482, and a diversity selection portion 483 (or “postamble”) comprising five repeated channel probing OFDM short-symbols 484, 485, 486, 487, 488. While use of the already available short-symbols from the IEEE 802.11a/HiperLAN2 preamble is convenient, it should be well understood that OFDM symbols of many different designs, lengths and types that have both non-zero and zero frequency bin content structure may be used in the present invention, one example of which is illustrated in FIG. 12.

As described above with respect to FIGS. 7, 8 and 9, all of the available diversity antenna elements are cycled through at the end of the received signaling (e.g., received burst transmitted within a MAC frame structure) and “scored”. In accordance with an embodiment of the present invention, the CNIR estimates are computed by using OFDM symbols that have both non-zero and zero frequency bin content. The non-zero OFDM bin locations are denoted by the bin index values:

sε{Non-zero OFDM Bin Indices} (2)

The zero OFDM bin locations are denoted by the bin index values:

tε{ZeroPower OFDM Bin Indices} (3)

As such, the estimate for the CNIR for the k^{th} frequency bin using antenna I after one observation frame, i.e., CNÎR_{k,l}, are given by:

$$C \hat{N} I {R}_{k , l} = \frac{( \sum signal + noise bins within \pm w bins of bin k )}{( \sum noise only bins within \pm w bins of bin k )} - 1 \qquad ( 4 )$$

where w is an integer and defines a window of bins centered at bin k that are effectively averaged to determine the estimate of the CNIR for the k^{th} bin. The signal+noise bins and the noise only bins are measured in power, e.g., the power of the k^{th} bin (whether signal+noise or noise only) of the l^{th} antenna branch may be determined using the Iₖ and Qₖ outputs of the FFTs according to I²_{k,l}+Q²_{k,l}. Equation (4) provides for the interpolation of the CNIR for each bin since only the signal+noise or only the noise is known for a given frequency bin. According to the approach of equation (4), the estimate of the CNIR is determined for all K bins of the OFDM signal, the estimate for each bin specified in equation (4).

In some embodiments, the values of C\hat{N}IR_{k,l} can be averaged or smoothed over several communication bursts in order to achieve a lower variance estimate for the C\hat{N}IR_{k,l} quantities. In some embodiments, the values of C\hat{N}IR_{k,l} are averaged or smoothed over several MAC frames to provide the lower variance estimate. One such simple recursion that provides a smoothed CNIR for the k^{th} frequency bin using antenna l, i.e., SC\hat{N}IR_{k,l}, is given by:

SC\hat{N}IR_{k,l}=βC\hat{N}IR_{k,l}+(1−β)SC\hat{N}IR_{k,l} (5)

where β is a smoothing parameter having an absolute value less than unity.

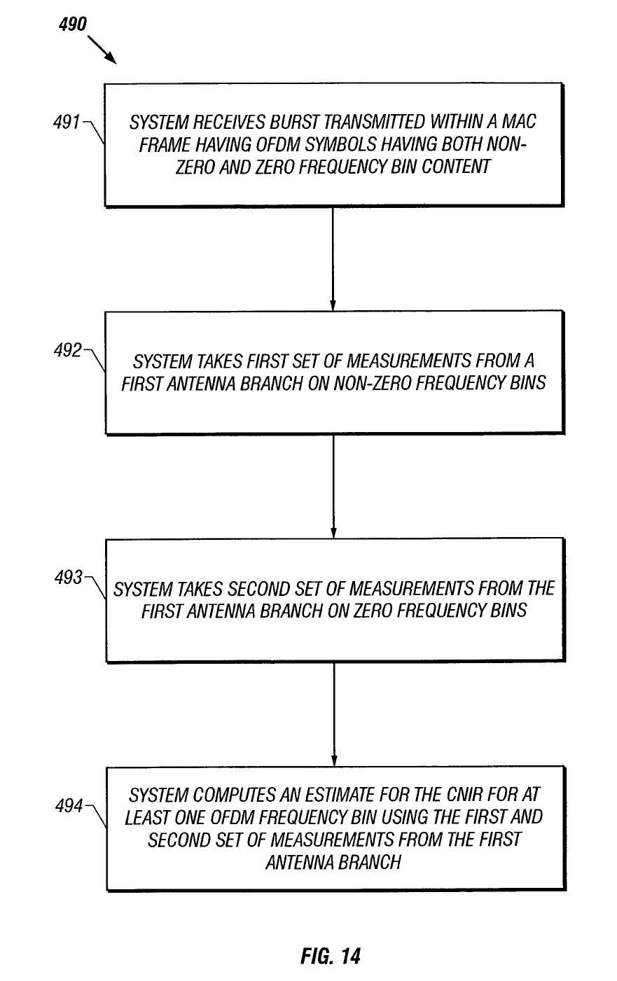

FIG. 14 illustrates a method in accordance with one embodiment of the present invention that is useful for communicating OFDM signals in that it provides a convenient method for estimating the CNIRs of one or more frequency bins of the OFDM signal for a given antenna branch using the above described concepts. In step 491, a communication burst (e.g., transmitted within a PHY-layer or MAC frame structure) is received by a system having L antenna branches and n RF receivers, such as for example the system 100 (FIG. 1) described above. The burst includes a diversity selection portion comprising one or more OFDM symbols that each have a frequency bin structure that includes both non-zero and zero OFDM frequency bin content, such as for example the diversity selection portion 483 (FIG. 13) or the diversity selection portion 578 (FIG. 9). For example, in one embodiment, the OFDM symbols have a zero and non-zero frequency bin content as illustrated in FIG. 11 or FIG. 12. In step 492 the system takes a first set of measurements from a first of the L antenna branches during the non-zero OFDM frequency bins. This first set of measurements correspond to the carrier+noise+interference power because the OFDM frequency bins are non-zero. In step 493, the system takes a second set of measurements from the first of the L antenna branches for the zero OFDM frequency bins. This second set of measurements corresponds to the noise+interference power because the OFDM frequency bins are zero. In step 494 an estimate for the CNIR for at least one frequency bin of the first of the L antenna branches is computed using the first and second set of measurements. In preferred embodiments, an estimate of the CNIR for every frequency bin (e.g., including all of the non-zero and zero frequency bins) is computed using the first and second set of measurements.

It should be well understood that the first and second sets of measurements do not have to be taken in any particular order. In a typical scenario, as the system cycles through all of the OFDM sub-carriers, the measurements taken on the non-zero bins will be placed in the “first set of measurements”, and the measurements taken on the zero bins will be placed in the “second set of measurements”. Thus, the taking of the first set of measurements and the taking of the second set of measurements may be interleaved.

The first and second set of measurements typically comprise power measurements, such as the complex receiver fast Fourier transform (FFT) output values. In order to compute the estimate for CNIR of each bin, equation (4) may be used. For example, the power measurements of the signal+noise bins within a window of bins surrounding bin k are summed and divided by the summation of the power measurements of the noise only bins within a window of bins surrounding bin k, then 1 is subtracted from the resulting quotient. The approach of equation (4) is used since for a given bin, either the signal+noise measurement is known or the noise only measurements is known. Thus, equation (4) averages the measurements of the surrounding bins to interpolate the CNIR for a particular bin. A smoothed value for the CNIR of each bin over multiple MAC frames may then be computed using equation (5).

Estimated values for the CNIRs of the frequency bins for the remainder of the L antenna branches may then be computed in a similar manner. Specifically, estimates for the CNIRs for the additional antenna branches may be made by measuring n antenna branches at a time during different antenna branch probing portions. For each antenna branch, the system takes a first set of measurements on the non-zero OFDM frequency bins and a second set of measurements on the zero OFDM frequency bins.

A transmitter of a communication terminal that transmits OFDM signals to the receiving system (such as the system 100 (FIG. 1)) will typically generate the communication burst including the appropriate OFDM signals and transmit them according to the timing provided in the specified MAC frame structure or format. In one embodiment of the present invention, the burst will include a preamble portion, a data portion following the preamble portion, and a diversity selection portion following the data portion. The diversity selection portion, as described above, includes one or more OFDM symbols that each have a frequency bin structure that includes both non-zero and zero OFDM frequency bin content. The transmitter transmits the communication burst with the diversity selection portion to the receiving system.

This technique for estimating the bin level CNIRs is very beneficial because not only does it accurately permit determination of a quality estimate for the bin-by-bin and aggregate CNIR of a received OFDM signal, but it also does so without imposing any additional overhead on the system communication throughput beyond that already needed to support diversity antenna scoring. The resultant estimates can be used to influence the selection of SNR-sensitive parameter choices such as for tracking loops, as well as be used for declaring erasures related to forward error correction techniques.

Tracking loops normally exhibit a dependency on the received signal SNR. Loop parameters like the effective noise bandwidth are advantageously reduced if the SNR becomes small and advantageously increased if the SNR is large enough to afford removal of close-in phase noise of the receiver's local oscillators.

In the case of forward error correction coding, FEC techniques typically exhibit thresholds below which the bit error rate performance is actually better without using any FEC. In addition, FEC codes are generally capable of detecting more errors than they are capable of correcting. An accurate bin-by-bin knowledge of the CNIRs provided by the present invention permits OFDM frequency bins that exhibit inadequate CNIR to be declared as erasures, thereby improving the error correction capability of the FEC.

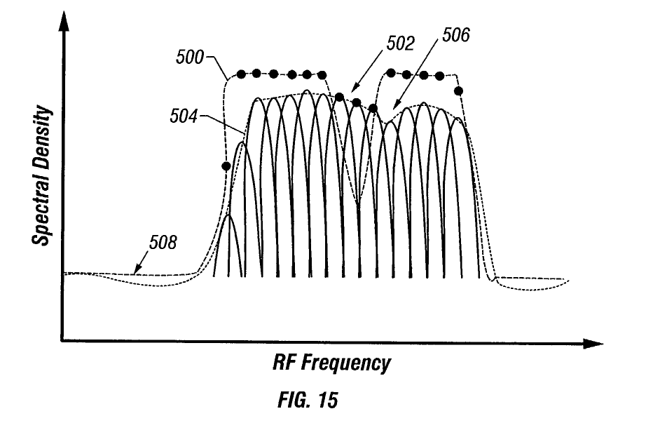

It was mentioned above that the function of selecting the two best branches from the L=6 diversity branches B1, B2, B3, B4, B5, B6 is performed by the diversity antenna selection and sub-carrier selection diversity module 108 (FIG. 1). Such selection diversity is somewhat complex with wideband OFDM in which many sub-carriers are involved along with frequency-selective fading. For example, the received signal spectrum for two different diversity branches may appear as shown in FIG. 15. By way of example, the two signal spectrum 500 and 504 represent the spectrum of the two best antenna branches as selected by the diversity antenna selection process. Illustrating frequency selective fading, one signal spectrum 500 includes a deep fade 502 at one RF frequency, and the other signal spectrum 504 includes a deep fade 506 at a different RF frequency.

FIG. 15 also illustrates sub-carrier selection (also referred to as bin selection) that is also performed by the diversity antenna selection and sub-carrier selection diversity module 108 of FIG. 1. The dots represent the antenna branch selected for each bin on a bin-by-bin basis between the two best antenna branches. As can be seen, the antenna receiving the highest spectral density is selected for each bin out of the two best antenna branches. For example, the antenna branch receiving signal spectrum 500 is selected for most bins across the modulation bandwidth, with the other antenna branch receiving signal spectrum 504 being selected for bins when signal spectrum 500 experiences the deep fade 502. It is noted that it has been assumed that the noise+interference level is constant and equal to the floor level 508 illustrated in FIG. 15.

Since the channel fading is frequency selective, choosing which branch to select preferably weighs the benefit to all of the OFDM subchannels. In general, it is much less desirable to simply compute the total power in the available branches and base the selection process on this kind of metric because this approach will clearly be susceptible to deep fades.

The following discussion sets forth an antenna branch selection method in accordance with an embodiment of the present invention. Preferably, the antenna branch selection method computations are performed during reception of one or more bursts transmitted within each MAC frame and the computed results are made use of in subsequent bursts within the same MAC frame or in an immediately following frame. In preferred embodiments, making use of the results for bursts received in the following MAC frame alleviates the potential computational bottleneck of computing and using the computed results for subsequent bursts received during the same MAC frame. Such potential computational bottleneck can result from the extremely high peak computational load placed on the signal processing involved due to the receive branch selection processing having to be completed before the channel data begins arriving. It should be well understood, however, that performing the antenna branch selection method computations during each MAC frame and using the computed results in the immediately following frame is not a requirement of the present invention. In other embodiments, the overall antenna scoring result may also be averaged over multiple postambles of multiple bursts in multiple MAC frames in order to improve the reliability of the antenna selection process. For example, in some embodiments, the antenna scoring results are averaged over multiple postambles such that the best antenna pair from the multiple postambles is determined and selected every m MAC frames.

With respect to the exemplary antenna branch selection method described herein, if two out of L-branches are selected for the case of n=2, the bit error probability for the complete OFDM symbol assuming bin-level selection diversity, i.e., Pb_{i,j}, is given by:

$$P {b}_{i , j} = \frac{1}{K} {\sum }_{k = 1}^{K} min ( P {b}_{i , k} , P {b}_{j , k} ) \qquad ( 6 )$$

where k is the frequency bin index (or subcarrier index), K is the total number of OFDM data-bearing sub-carriers (or bins) and i and j represent the indices of the two antenna branches selected among L possible diversity branches. Therefore, in accordance with an embodiment of the present invention, the diversity antenna branch selection decision will be the antenna pair with indices i₀ and j₀ such that Pbᵢ_{_{0,}}^{j}_{ₒ} is minimized.

For binary phase-shift keying (BPSK) modulation, the bit error probability is:

$$P {b}_{B P S K} = Q ( \sqrt{\frac{2 {E}_{b}}{{N}_{0}}} ) \qquad ( 7 )$$

And for M-ary quadrature amplitude modulation (QAM), Mε{4,16,64}, the symbol error probability is:

$$P {s}_{M - Q A M} = 1 - {( 1 - 2 ( 1 - \frac{1}{\sqrt{M}} ) Q ( \sqrt{\frac{3}{M - 1} \frac{{E}_{ave}}{{N}_{0}}} ) )}^{2} \qquad ( 8 )$$

where

$$\frac{{E}_{ave}}{{N}_{0}}$$

is the average SNR per symbol, and

$${P}_{\sqrt{M}} = 2 ( 1 - \frac{1}{\sqrt{M}} ) Q ( \sqrt{\frac{3}{M - 1} \frac{{E}_{ave}}{{N}_{0}}} ) \qquad ( 9 )$$

is the probability of error of a ¢M -ary pulse-amplitude modulation (PAM) with one-half the average power in each quadrature signal of the equivalent QAM system.

For simplicity, without considering gray encoding, any small bit error probability (≦3%) can be approximated with:

$$P {b}_{M - Q A M} \approx \frac{P s}{B} , where B = {log}_{2} M . \qquad ( 10 )$$

where B is the number of bits/symbol. For fixed point application-specific integrated circuit (ASIC) implementation, Q(x) can be approximated with the following equations:

$$Q ( x ) \approx \begin{matrix}0.50 - 0.1 x ( 4.4 - x ) & 0 \leq x \leq 2.2 \\ 0.01 & 2.2 < x < 2.6 \\ 0.0 & x \geq 2.6\end{matrix} \qquad ( 11 )$$

This Q-function approximation results in a worst case absolute error of 0.0533. An alternative approach is to use a table lookup that covers the dynamic range for all modulation schemes (BPSK and M-QAM).

In power-based approaches (as described above), because of the finite dynamic range in approximating Q(x) and the SNR Eₐᵥₑ/N₀ is approximated with I²+Q² by using the fast Fourier transforms (FFTs) in the receivers 104,106 (FIG. 1), which is not actual SNR but signal plus noise, and with the assumption that channel fading patterns are changing slowly between consecutive bursts (e.g., transmitted within the same or consecutive MAC frames) and remain flat (static) within each sub-carrier bandwidth, when selecting the best pair of antenna for reception, it suffices to select i and j such that the following quantity is minimized:

$${χ}_{i , j} = {\sum }_{k = 1}^{K} min \{ Q ( α {\sqrt{[ \frac{{E}_{s - ave}}{{N}_{0}} ]}}_{k , i} ) , Q ( α \sqrt{{[ \frac{{E}_{s - ave}}{{N}_{0}} ]}_{k , j}} ) \} \qquad ( 12 )$$

where

$$\frac{{E}_{s - ave}}{{N}_{0}}$$

is the estimated SNR for the k^{th} bin using the specified antenna (i.e., either antenna i or j), k is the frequency bin index, K is the total number of data-bearing subcarriers, i and j are the selected antenna pair, and α is a parameter used to accommodate different QAM signals, where

$$α = \sqrt{\frac{3}{M - 1}} ,$$

where M is the constellation size of an M-QAM signal. Therefore, i=iₒ and j=jₒ are chosen such that λᵢₒ,ⱼₒ is minimized, with the antenna branches corresponding to iₒ and jₒ being the two selected branches.

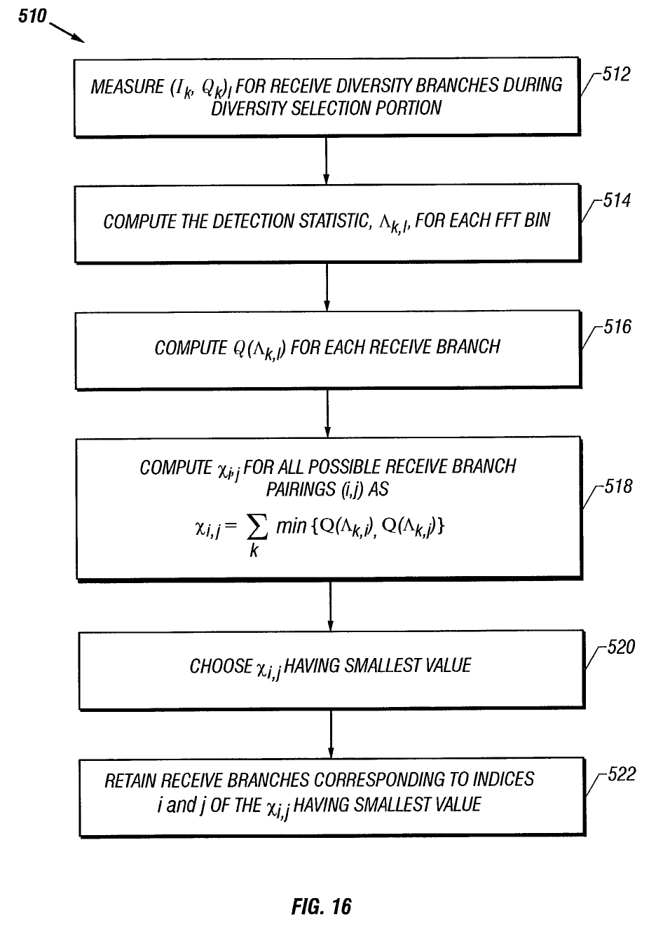

It is noted that equation (12) provides a relationship to be used in the power-based approach of several embodiments of the invention. The above described CNIR-based approach of several embodiments of the invention uses a similar relationship as defined in equation (12); however, the quantity within the Q function is determined differently and will be described below with reference to FIG. 16.

An exemplary implementation of the antenna branch selection method of the present invention is based upon the evaluation of equation (12) to measure the probability of bit error metrics for all possible combinations or groupings of antenna branch pairs during a diversity selection portion of a communication burst transmitted within a MAC frame as described above. The calculated metrics are preferably used in the selection decision of the best antenna pair choice for the reception in a subsequent burst received in the same or a subsequent MAC frame (preferably, transmitted in the next MAC frame). As mentioned above, without this allowed delay, the computations required in a very short period of time are excessive.

In accordance with an embodiment of an antenna branch selection method of the present invention, measurements are taken from L different antenna branches n antenna branches at a time. The measurements are processed and are used to identify a group or combination of n of the L different antenna branches that are the best antenna branches in terms of the channel bit error rate or symbol error rate. The identified group or combination of n antenna branches are then selected for the sub-carrier selection stage. In the illustrated case of n=2, a group of two antenna branches are identified and selected for use with the two RF receivers 104,106 (FIG. 1). It should be understood that a group may include one or more antenna branches, which provides for n≧1.

In general, the best group or combination of n antenna branches are identified by identifying a group of n antenna branches that minimizes an approximated bit error probability of the subsequent OFDM signal (e.g., a subsequent burst) that will eventually be constructed during the sub-carrier selection stage. As will be discussed below, during the sub-carrier selection stage, each final OFDM sub-carrier is selected from the two receiving RF channels (for n=2) which have been coupled to the two selected antenna branches. To minimize the overall bit error rate, the sub-carrier selection stage makes decisions on a bin-by-bin basis, selecting the best sub-carriers from each receiving RF channel. But because the diversity antenna branch selection stage normally selects the best antenna branches prior to the sub-carrier selection stage, the selection is made by minimizing an approximated bit error probability of the final OFDM signal that will eventually be constructed from the OFDM sub-carriers that are each received by either one of the two identified best antenna branches. More generally, the best n antenna branches are selected by identifying a group of n of the L different antenna branches that minimizes an approximated bit error probability of a subsequent signal (e.g., subsequent burst) that will eventually be constructed from sub-carriers that are each received by any one of the n antenna branches in the identified group of n antenna branches.

Accordingly, FIG. 16 illustrates an exemplary antenna branch selection method 510 in accordance with an embodiment of the present invention. Specifically, in step 512 the L different diversity antenna branches are measured n antenna branches at a time during the diversity selection portion of the received burst transmitted within a MAC frame structure. For example, these measurements are obtained from signaling received during the probing portions of the communication bursts as variously described herein. The measurements are provided to the module 108 (FIG. 1) as the FFT outputs for each branch. The (Iₖ, Qₖ) measurements for the k^{th} FFT bin of the l^{th} receive branch are represented herein by (Iₖ, Qₖ)ₗ. The measurements comprise power measurements of each of the K sub-carriers, i.e., FFT bin outputs.

In step 514 a detection statistic corresponding to each FFT bin output is computed. This may be done differently depending on the embodiment of the invention and depending on the type of OFDM symbol that is being received for diversity selection purposes. One approach is a power-based approach and another is a CNIR-based approach.

According to the power-based approach, the OFDM probing symbol is an OFDM symbol in which all of the frequency bins have signal content, e.g., the OFDM long symbols described above. As such, the detection statistic Λ_{k,l} for each FFT bin, i.e., each k^{th} frequency bin of the OFDM symbol from the l^{th} antenna is taken according to the following equation:

Λ_{k,l}=α¢I²_{k,l}Q²_{k,l} (13)

where is α is the parameter used to accommodate different QAM signals as described above. In the power-based embodiment, all of the FFT bin values (signal strength for each bin) are preferably made using the same radio automatic gain control (AGC) setting. Thus, in this embodiment, gain differences between the two physical receive chains must be addressed and is discussed further below. Furthermore, in the power-based approach, a measure of noise (N₀) may be needed to determine the Q functions and may be determined a number of ways as are known in the art.

In the CNIR-based approach, the detection statistic A_{k,l} corresponding to each bin is expressed according to the following equation:

Λ_{k,l}=α¢C\hat{N}IR_{k,l} (14)

where C\hat{N}IR_{k,l} is the estimated CNIR as described above (e.g., in equations (4) and (5)) and a is the above described parameter depending on the modulation. Advantageously, this approach is preferred since there is no need to worry about gain differences between the two receivers, the real bit error rate depends on the CNIRs and since this approach is not adversely affected by the presence of interference.

In step 516 approximate bit error probability values Q(Λ_{k,l}) are computed for each receive branch. The Q-function may be approximated as described above, using the appropriate detection statistic as the argument. The approximate bit error probabilities, as well as the detection statistics computed in step 514, are preferably computed for each of the K sub-carriers for each of the L antenna branches, n antenna branches at a time. Furthermore, the Q-function is determined differently depending on whether the power-based or the CNIR-based approach is used.

In step 518 the chi values λ_{i,j} for all of the possible receive antenna branch pairings (i,j) are computed as follows:

$${χ }_{i , j} = {\sum }_{k} min \{ Q ( {Λ}_{k , i} ) , Q ( {Λ}_{k , j} ) \} \qquad ( 15 )$$

Equation (15) basically selects a minimum one of the approximate bit error probabilities for each k^{th} of the K sub-carriers for each different grouping or combination of two antenna branches (n=2). The minimum ones of the approximated bit error probabilities are then summed for each different grouping or combination of two antenna branches. By way of example, for the n=2, L=4-branch case, the possible chi values that can be considered are λ_{1,2}, λ_{1,3}, λ_{1,4}, λ_{2,3}, λ_{2,4} and X_{3,4}. In general, there are L(L-1)/2 different cases (chi values) to consider for an L-branch system having n=2.

In the power-based approach, equation (15) is written as:

$${χ}_{i , j} = {\sum }_{k} min \{ Q ( α \sqrt{{I}_{k , i}^{2} + {Q}_{k , i}^{2}} ) , Q ( α \sqrt{{I}_{k , j}^{2} + {Q}_{, j}^{2}} ) \} \qquad ( 16 )$$

Note that equation (16) is closely related to equation (12), the term

$$\frac{{E}_{s - ave}}{{N}_{0}}$$

of equation (12) being approximated as I²+Q² as described above.

In the CNIR-based approach, equation (15) is written as:

$${χ}_{i , j} = {\sum }_{k} min \{ Q ( α \sqrt{C \hat{N} {IR}_{k , i}} ) , Q ( α \sqrt{C \hat{N} {IR}_{k , j}} ) \} \qquad ( 17 )$$

It is noted that the parameter a may be different in equation (16) compared to the parameter a used in equation (17) due to AGC issues relating to the power-based approach.

Given the chi terms computed for a given evaluation interval, in step 520 the chi value λ_{i,j} having the smallest value is determined and the i, j indices saved. In other words, the sum of the minimum approximate bit error probabilities having the smallest value is determined. The i, j indices correspond to the receive branches that should be retained for best reception of the multipath-corrupted OFDM signal. In step 522 the receive branches corresponding to indices i and j of the chi value λ_{i, j} having the smallest value is retained for the duration of the next one or more bursts, e.g., of the same MAC frame or the next MAC frame. In this way, the grouping of n antenna branches that produced the sum of the minimum approximated bit error probabilities having the smallest value is selected.

For L>4, the number of terms and calculations becomes excessive, and it is preferable to only examine a subset of the different chi terms available. An approach in accordance with an embodiment of the present invention is to compute at most 6 chi-values, taking the worst 2 chi-values measured in each received burst and replacing them with measurements of 2 new possible receive branch pairings during reception of subsequent bursts (either later in the same MAC frame or in the next MAC frame). In this manner, the routine automatically throws away the worst 2 branch pairings in its unending search to find 2 better branch pairings.

As an example, assume that L=5 receive branches are available. This means that there are a total of 5*4/2=10 possible chi values that need to be considered. Assume further that the best 6 chi terms are (in descending order of quality): λ1,2, λ2,3, λ1,4, λ2,5, λ4,5 and λ1,5. During the next opportunity to evaluate the receiver branch selection metrics, the last two chi terms (λ4,5, and λ1,5) are dropped and two of the remaining pair possibilities are examined instead: λ1,3, λ2,4, λ3,4 and λ3,5.

Thus, if there are L=6 antennas available, the diversity antenna selection can be based on 4 antennas' measurements (i.e., 6 chi terms) and then the remaining pairs are swapped with the other 2 worst antennas for the next diversity antenna selection performed using subsequent received bursts, again, either later in the same frame or in the next MAC frame.

The above-described computations may be executed for every different user stream being received by the system 100 (FIG. 1). Because many different user streams can be involved, the diversity antenna selection and sub-carrier selection diversity module 108 (FIG. 1) may be configured to keep track of the best indices pairs (i,j)ₘ for the m^{th} user stream. This is a very desirable capability in an access point or base station which purposely receives traffic from multiple concurrent user streams. Such configuration, however, is not a requirement of the present invention.

As mentioned above, for embodiments using the power-based approach in step 514, rather than the CNIR-based approach, if the signal gain through the (in the case of n=2) two receive chains is different for the same AGC setting, computation of the chi values λ_{i,j} in step 518 will be biased in favor of the receiver chain having the larger gain. In order to prevent this problem, the gain between the two receive chains involved may be accurately calibrated. One exemplary way to perform such a calibration is as follows. With the system 100 shown in FIG. 1, it is possible to switch any one of the L antenna branch inputs B1, B2, B3, B4, B5, B6 to either of the two receive chains 104, 106. Specifically, an antenna selection stage 101 is configured to allow each of the two RF receivers 104,106 to be coupled to any one of the L different antenna branches B1, B2, B3, B4, B5, B6. The calibration between the two receive chains 104, 106 can then be done by measuring the signal power using one of the L branches connected to the first receive chain 104, and then quickly switching the same antenna branch to the second receive chain 106 and measuring the receive power a second time. This data can be used to compute an appropriate scale factor. Gain differences or AGC setting differences between the two physical receive chains 104,106 can be compensated by multiplying Λ_{k,l} with the appropriate scale factor. In this way different receive chain signal gains can be dealt with so that all of the FFT bin signal strength measurements can be made using the same radio AGC setting. Again, using the CNIR-based approach for step 514, this AGC issue is avoided.

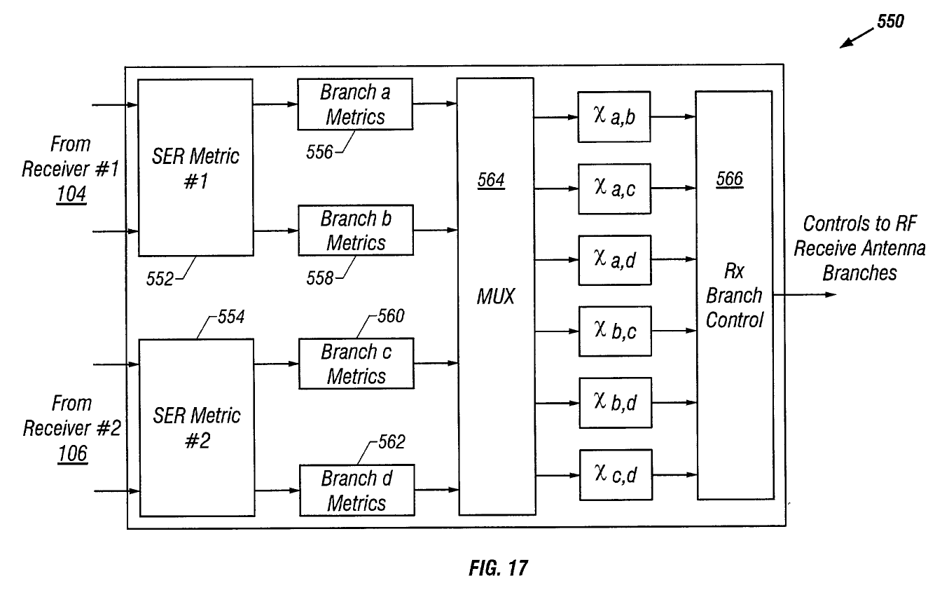

Referring to FIG. 17, there is illustrated a high-level block diagram of an exemplary diversity antenna branch selection module 550 made in accordance with an embodiment of the present invention. The module 550, which may be used in the diversity antenna selection and sub-carrier selection diversity module 108 (FIG. 1), is capable of operating in accordance with the antenna branch selection method 510 shown in FIG. 16. Specifically, when the L available receive diversity branches are measured during the diversity selection portion of a received communication burst (transmitted within a MAC frame) pursuant to step 512 of the method 510, the channel estimates are provided to the Symbol Error Rate (SER) metric computation blocks 552, 554 as the FFT outputs from each of the RF receivers 104, 106 (FIG. 1). As mentioned above, the (lₖ, Qₖ) measurements for the k^{th} FFT bin of the l^{th} receive branch are represented by (Iₖ, Qₖ)l. These FFT estimates are made two at a time since in this case there are two complete RF receivers but L-branches (i.e., antennas) to consider.

The SER metric computation blocks 552, 554 perform steps 514 and 516 of the method 510 by computing the detection statistic corresponding to each frequency bin Λ_{k,l} and then the approximate bit error probability Q(Λ_{k,l}). The Q(Λ_{k,a}) values for antenna branch “a” are stored in branch a metrics 556, the Q(Λ_{k,b}) values for antenna branch “b” are stored in branch b metrics 558, the Q(Λ_{k,d}) values for antenna branch “c” are stored in branch c metrics 560, and the Q(Λ_{k,d}) values for antenna branch “d” are stored in branch d metrics 562.

A multiplexer 564 is used to form the possible receive antenna branch pairings or groupings from among the L different antenna branches for the execution of step 518. For example, in order to compute the chi value λ_{a,d,} the multiplexer 564 makes available the Q(Λ_{k,a}) values stored in branch a metrics 556 and the Q(Λ_{kd}) values stored in branch d metrics 562 for calculation in the equation

$${χ}_{a , d} = \sum min \{ Q ( {Λ}_{k , a} ) , Q ( {Λ}_{k , d} ) \} .$$

A receive branch control block 566 performs step 520 by determining the λ_{i,j} having the smallest value. The receive branch control block 566 then generates an output signal to control the RF receive branches to retain the braches corresponding to indices i and j of the λ_{i,j} having the smallest value for the execution of step 522.

The diversity antenna branch selection module 550 as shown in FIG. 17 is configured to examine L=4 different receive antenna branches at a time due to its capacity to calculate six different chi values λ_{i,j}. As described above, if more receive branches are available, the poorest 2 branches measured for bursts received during the previous MAC interval can be replaced by using those measurement slots to examine 2 new branches, with the process continuing in this manner.

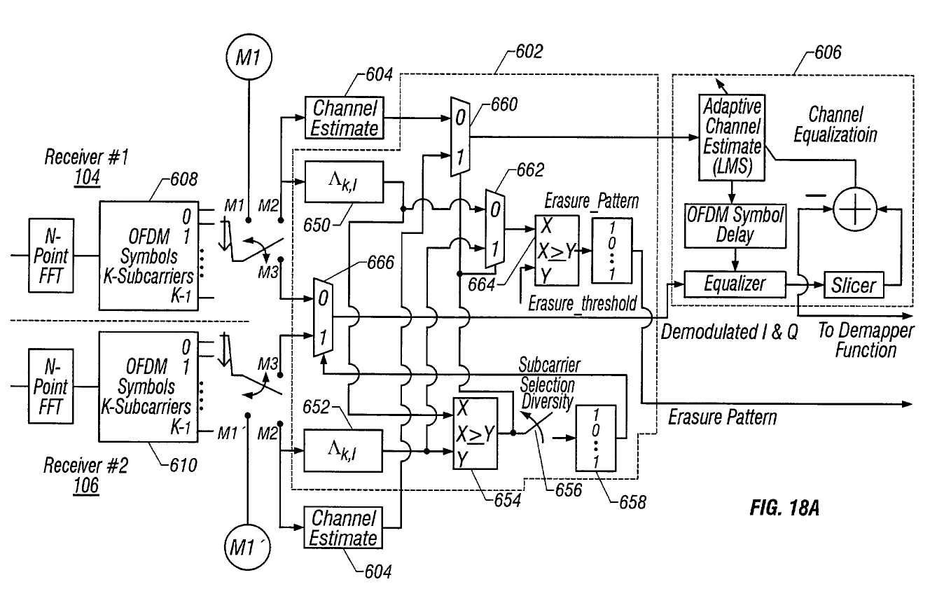

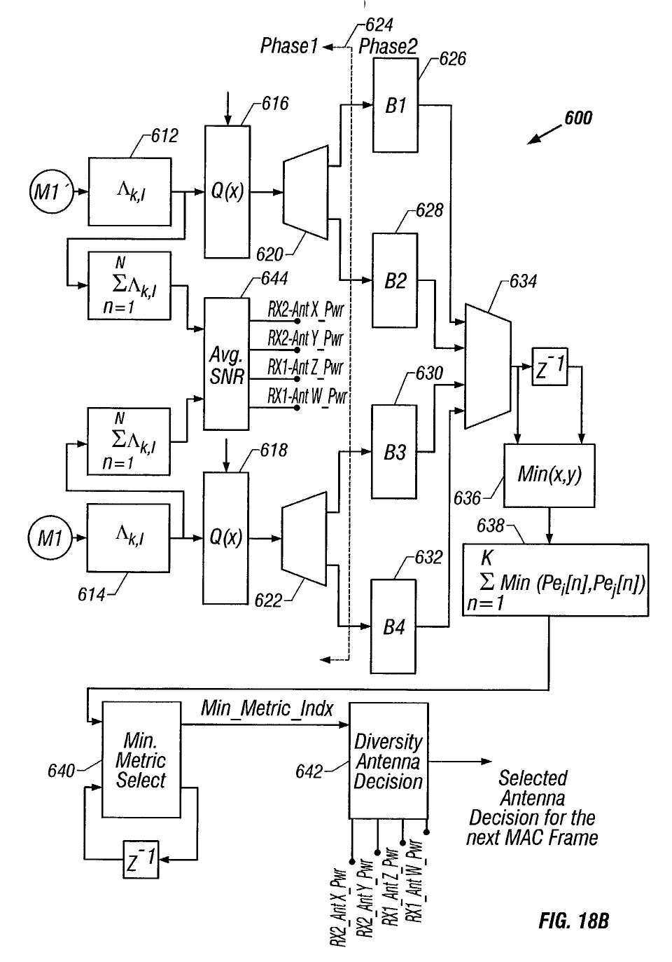

Referring to FIGS. 18A and 18B, there is illustrated exemplary implementations of and a sub-carrier (or bin) selection diversity module 602 and a diversity antenna selection module 600, respectively, made in accordance with several embodiments of the present invention. The modules 600 and 602 may be used to form the diversity antenna selection and sub-carrier selection diversity module 108 (FIG. 1). The RF receivers 104, 106, channel estimate modules 604, and a channel equalization module 606 are also included in the figure for an overview of the system interfaces and interactions between these modules. The RF receivers 104, 106 include blocks 608, 610, respectively, illustrating the K sub-carriers of the OFDM signals. Each of the K sub-carriers may be coupled to the diversity antenna selection module 600, the channel estimate modules 604, or the sub-carrier selection diversity module 602 by means of nodes M1, M2, M3, respectively.

The diversity antenna branch selection module 600 operates in a manner similar to the diversity antenna branch selection module 550 (FIG. 17). The module 600 is configured to examine L=4 different receive antenna branches at a time, but it should be well-understood that the module 600 can be used to examine L>4 different receive antenna branches by dropping one or more of the poorest branches measured for bursts received during the previous MAC interval and using those measurement slots to examine new branches as described above.

The antenna diversity processing can be sub-divided into two phases: the real time Phase1 (to the left of dotted line 624) and the non-real time Phase2 (to the right of dotted line 624). Phase1 may also be referred to as a first computation stage, and Phase2 may also be referred to as a second computation stage. Phase1 preferably runs during the reception of the diversity selection portion of a received burst. The L available receive diversity branches are measured during the diversity selection portion of the burst pursuant to step 512 of the method 510 (FIG. 16) by coupling the K sub-carriers of the OFDM signals to the diversity antenna selection module 600 by means of nodes M1, M1′.

The channel estimates (Iₖ, Qₖ)ₗ are provided to the detection statistic blocks 612, 614, which perform step 514 of the method 510 by computing Λ_{k,l}, either using the power-based approach of equation (13) or the CNIR-based approach of equation (14), depending on the type of OFDM probing symbol used in the diversity selection portion of the burst. The computation blocks 616, 618 perform step 516 of the method 510 by computing Q(Λ_{k,l}). Thus, the detection statistic blocks 612, 614 are configured to compute a detection statistic for each of the K sub-carriers (as a raw power level or a CNIR), and the computation blocks 616, 618 are configured to process the detection statistics by approximating the Q-function.

The antenna switch multiplexer 620 multiplexes the Q(Λ_{k,l}) data between memory 626 and memory 628, and the antenna switch multiplexer 622 multiplexes the Q(Λ_{k,l}) data between memory 630 and memory 632. The memories 626, 628, 630, 632, which may comprise random access memories (RAMs), are used to store intermediate metric values for non-real time processing. By way of example, the memories 626, 628, 630, 632 may each be capable of storing K measurements, where K is the number of sub-carriers (e.g., K=52, 68, 84,or 100). This way, each of the four memories 626, 628, 630, 632 can be used to store the approximate probability bit error metrics Q(Λ_{k,l}) for one of the L=4 antenna branches. Namely, memory 626 stores the Q(Λ_{k,1}) data for antenna branch B1, memory 628 stores the Q(Λ_{k,2}) data for antenna branch B2, memory 630 stores the Q(Λ_{k,3}) data for antenna branch B3, and memory 632 stores the Q(Λ_{k,4}) data for antenna branch B4. When the last metric value is stored in memory 632, all of the blocks in Phase1 become inactive.

In Phase2, the multiplexer 634 sequentially multiplexes different combinations or groupings of the Q(Λ_{k,l}) data stored in the memories 626, 628, 630, 632 to begin the calculation of the chi values λ_{i,j} pursuant to step 518 of the method 510. In this way the multiplexer 634 forms different groupings of n antenna branches from among the L different antenna branches. The minimum value of each combination of the Q(Λ_{k,l}) data is determined in the minimum function computation block 636, which selects a minimum one of the approximate bit error probabilities for each one of the K sub-carriers for each different grouping of n antenna branches. The summation operation is performed in summation computation block 638, which sums the minimum ones of the approximate bit error probabilities that were selected for each one of the K sub-carriers for each different grouping of n antenna branches.

The chi value λ_{i,j} having the smallest value is determined by a minimum metric selection module 640 pursuant to step 520 of the method 510. A diversity antenna selection decision module 642 generates an output signal to indicate the selected antenna pair decision for subsequent OFDM bursts received (e.g., later in the current MAC frame or in the next MAC frame) pursuant to step 522 of the method 510. This output signal controls the RF receive branches to retain the branches corresponding to indices i and j of the λ_{i,j} having the smallest value.

An average SNR block 644 may be used to store intermediate SNR/power values for non-real time processing. By way of example, the average SNR block 644 may include four memory locations for holding the average SNR across all FFT bins for the four antenna branches B1, B2, B3, B4 (with one measurement per antenna branch). In the case of when there is one dominant branch, the metrics of all the possible combination antenna pairs may all be dominated by the same antenna and result in the same value. The average SNR metrics are then used in the selection decision process to ensure that the selected antenna pair corresponds to the best antenna choice for the second receiver.

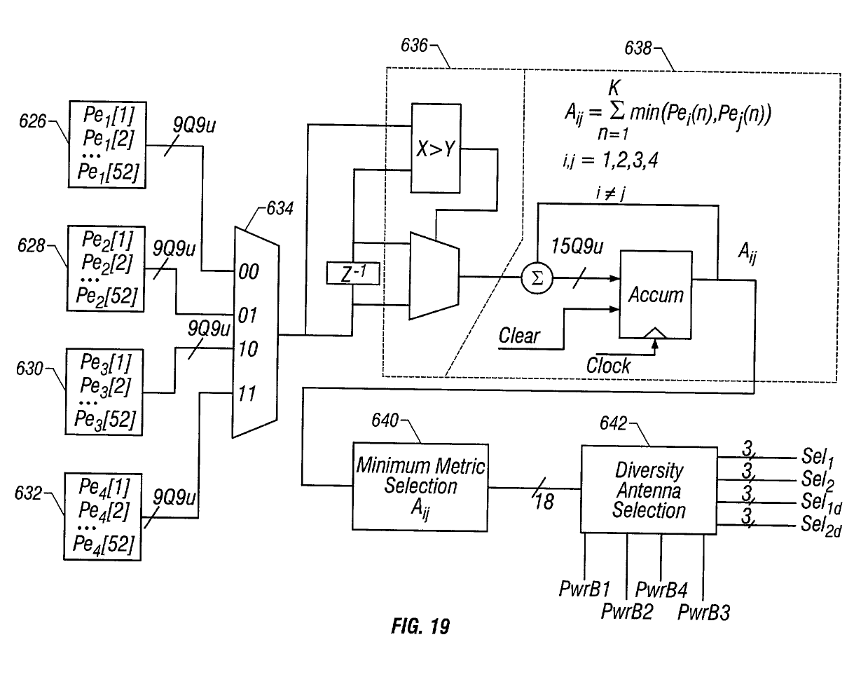

Referring to FIG. 19, the minimum metric selection module 640 reports the i & j indices that correspond to the smallest metric. By way of example, the i & j indices that correspond to the smallest metric may be encoded with 3 bits. The output is packed into an 18-bit word for the worst case of three antenna pairs with equal metrics for the L=6 case. A “000” index may be used as a filler when there are only one or two antenna pairs selected.

A programmable register may be used for initialization in the diversity antenna selection decision module 642 for the first received burst after the unit is powered up. The antenna branches with indices Sel₁ and Sel₂ are used in the reception of the data portion, and the antenna branches with indices Sel₁, Sel₂, Sel_{1d}, Sel_{2d} are used in the diversity antenna selection in subsequent received communication bursts.

After the two antenna branches have been selected (in the n=2 scenario) from among the L antenna branches in the diversity antenna branch selection stage, the sub-carrier selection stage starts processing. As mentioned above, FIG. 18A illustrates an exemplary implementation of a sub-carrier selection diversity module 602 made in accordance with an embodiment of the present invention. The received OFDM symbols consist of many sub-carriers which experience different frequency selective channel fading patterns. The OFDM symbols used for bin-level diversity selection may be OFDM short symbols, OFDM long symbols, or other OFDM symbols, e.g., symbols having zero frequency bins and non-zero frequency bins. In the sub-carrier selection stage, each final OFDM sub-carrier is selected from the two receiving RF channels which have been coupled to the two selected antenna branches. To minimize the overall bit error rate, the sub-carrier selection stage makes decisions on a bin-by-bin basis among all the available receiving paths.

In embodiments using OFDM long symbols, upon the availability of the FFT of the long training symbols, the sub-carrier selection stage starts processing. In this embodiment, the sub-carrier selection decision is preferably based on the power measurements of the long training symbols. In other words, decisions are preferably made on a bin-by-bin basis by selecting winning bins with larger Λ_{k,l} between the two available branches, where Λ_{k,l} are measured on the FFT bins of the long training symbols.

In one embodiment, these selections are made as follows. During the reception of the long training symbols, the FFT output switch is in the M2 position. The power of each sub-carrier, i.e., the magnitude of each FFT bin, is computed by either the channel estimate blocks 604 or the detection statistic blocks 650, 652 (i.e., the power-based approach in step 514 of FIG. 16). The detection statistic block 650 computes the detection statistics of the sub-carriers from the first receiver 104 (i.e., Λ_{k,i}), and the detection statistic block 652 computes the detection statistics of the sub-carriers from the second receiver 106 (i.e., Λ_{k,j}). The values of Λ_{k,l} computed by the detection statistic blocks 650, 652 are compared with each other in a comparator 654. A decision of “0” is output from the comparator 654 if the Λₖ value of a sub-carrier from the first receiver 104 is greater; otherwise, a “1” is output. While these comparisons are being made the switch 656 is closed and the results, i.e., the “0” and “1” outputs from the comparator 654, are stored in a memory 658. It is noted that in embodiments using OFDM long symbols, the channel estimate blocks 604 are used to determine the detection statistics.

While the FFT output switch is still in the M2 position and the sub-carrier selection decisions are being made by the comparator 654, the output of the comparator 654 may be provided to a multiplexer 660 so that the sub-carrier selection decisions can be used to multiplex the channel estimates from the channel estimate modules 604. The output of the comparator 654 may also be provided to a multiplexer 662 so that erasures for a signal constellation demapping function can be declared in the case of very poor SNR on individual bins. The power of the winning bins may be compared by a comparator 664 with an erasure threshold in assigning the erasure declarations.

During the reception of the data portion, the FFT output switch is moved to position M3 and the switch 656 at the output of the comparator 654 is opened. The sequence of 0's and 1's that were recorded in the memory 658 for each frame are preferably used as a switch for a multiplexer 666 to multiplex the incoming channel estimates and I's and Q's samples output from the FFT. In other words, the sub-carrier selection decisions stored in the memory 658 are preferably used to control the multiplexer 666 to multiplex the subsequent OFDM sub-carrier data into the channel equalization module 606.

Thus, the final OFDM signal is constructed from the OFDM sub-carriers that are each received by either one of the two selected best antenna branches. The sequence of 0's and 1's that are stored in the memory 658 for each frame are used to identify which of the two antenna branches is receiving the better quality sub-carrier for each different value of K. The better one of the two sub-carriers for each value of K is multiplexed into the final OFDM signal by the multiplexer 666. By constructing the final OFDM signal with sub-carriers received by the two best antenna branches selected by the diversity antenna selection module 600, the final OFDM signal should have an approximate bit error probability that is smaller than it would have been if a different pairing of antenna branches were used. In this way the diversity antenna selection module 600 and the sub-carrier selection diversity module 602 help to reduce the effects of frequency-selective fading in OFDM communications. This makes the system 100 (FIG. 1) highly tolerant to multipath propagation and narrowband interference.

It is noted that in embodiments employing the CNIR-based approach to step 514 of FIG. 16, the detection statistic blocks 650, 652 determine the values of Λ_{k,l} for the antenna pair (e.g., as described in equation (4)) in use for subcarrier selection and erasure purposes. It is also noted that in preferred embodiments, the diversity selection portion of the received communication burst is positioned as a postamble, such that when performing subcarrier selection, the switch M2 is coupled to blocks 608 and 610 at the same time as the switch is coupled to M1. Thus, in one embodiment, frequency bin selection for a current burst (e.g., transmitted within a current frame) is based upon the Λ_{k,l}, measurements of the previous burst (e.g., transmitted previously within the same frame or transmitted in a previous frame) (which, in many embodiments, is also when the best antenna pair i and j for the current frame is determined). Thus, frequency bin selection operates similarly to that described above; however, the patterns of 1s and 0s for subcarrier selection and erasures are determined during the postamble of the previous burst (e.g., of the previous frame). As such, the FFT output switch is not moved to position M2 during the preamble portion of the current frame. However, the FFT output switch is moved to position M3 at during the reception of the data in the data portion of the burst, as described above so that the best antenna i or j may be selected for each frequency bin or subcarrier. In other words, the subcarrier selection decisions stored in the memory 658 are preferably used to control the multiplexer 666 to multiplex the OFDM subcarrier data into the channel equalization module 606.

It is further understood that the timing and positioning of the FFT output switch may be easily adjusted to accommodate differently formatted communication bursts transmitted within differently formatted MAC frames in which the diversity selection portion is located in different locations within the burst.

Referring next to FIGS. 20 and 21, timing diagrams are shown illustrating one embodiment of PHY-layer frame structure for a communication system including an access point (AP) and a plurality of remote terminals (e.g., RT1, RT2, RT3, etc.), and illustrating various communication bursts transmitted within the PHY-layer frame structure in accordance with another embodiment of the present invention.As is common in wireless indoor/outdoor LAN applications an access point communicates with multiple remote terminals. FIG. 20 illustrates a MAC frame structure 700 (also referred to as a MAC frame or frame) that may be used in such a system and in which employs diversity antenna selection and diversity subcarrier selection as described herein. The MAC frame structure 700 includes a beacon portion 702, a downlink portion 704 and an uplink portion 706. The beacon portion 702 contains a communication burst including a plurality of OFDM symbols that is broadcast from the access point (AP) to all remote terminals within range of the AP. As is illustrated, the beacon portion 702 is formatted into a preamble portion 708, a data portion 710 and a diversity selection portion 712. These portions may be as described herein with reference to FIGS. 5-10 and 13. The diversity selection portion 712 includes probing portions that contain OFDM symbols as described herein for the purpose of performing diversity antenna selection of n antenna branches out of L available antenna branches and sub-carrier selection to select the best antenna branch for each subcarrier or bin out of the best n antenna branches.

After the beacon portion 702 is the downlink portion 704 during which one or more bursts are transmitted. The downlink portion 704 is segmented into downlink data portions 714, 716, 718. For example, data is transmitted from the AP to remote terminal #1 (RT1) during downlink data portion 714, data is transmitted from the AP to RT2 during downlink data portion 716, and data is transmitted from the AP to RT3 during downlink data portion 718. It is noted that the beacon portion 702 and the downlink portion 704 are configured to contain OFDM signals transmitted as “downlink bursts”. It is also notes that signals transmitted during the beacon portion 702 and the downlink portion 704 may comprise a single communication burst or may comprise several bursts.

After the downlink portion 704 is the uplink portion 706 including remote uplink portions 720, 722, 724. Each of the remote uplink portions 720, 722, 724 is preceded by a time gap 732. Each remote uplink portion includes a preamble portion 726, a data portion 728 and a diversity selection portion 730. It is noted that each of the remote uplink portions 720, 722, 724 are configured to contain OFDM signals transmitted as “uplink bursts” from the respective one of the RTs. Thus, a respective communication burst made up of the appropriate OFDM signals (e.g., OFDM (symbols) is transmitted during each of the remote uplink portions 720, 722, 724.

In operation, the time gaps 732 are required to handle different propagation times for communications from each RT to the AP and so that the RT uplink sessions do not inadvertently overlap. A short preamble portion 726 is also required for each uplink session (i.e., each uplink burst) since the channel is always changing and so that the AP can acquire the proper timing, etc. to receive the contents of uplink transmission. Data from RT1 is transmitted to AP in the data portion 728 of remote uplink portion 720, data from RT2 is transmitted to AP in the data portion 728 of remote uplink portion 722, and data from RT3 is transmitted to AP in the data portion 728 of remote uplink portion 724. It is noted that diversity selection portions are not included within each downlink data portion 714, 716, 718 since this would be redundant to the diversity selection portion 712 of the burst transmitted during the beacon portion 702.

Also, a diversity antenna selection portion 730 is included within each of the remote uplink portions 720, 722, 724, illustrated as postambles of the bursts transmitted in the respective remote uplink portions. The inclusion of the diversity selection portions 730 is optional depending on the volatility of the uplink channel.

Each of the communicating devices may be configured to include a receiver similar to the receiver of FIG. 1. Thus, advantageously, the diversity antenna selection processes and sub-carrier selection processes described herein may be employed for signaling (e.g., communication bursts) received in the downlink and/or signaling received in the uplink.

Furthermore, when referring to PHY-layer or MAC frame structures herein, it is intended that term MAC frame is meant to include an entire MAC frame structure (such as MAC frame structure 700), or a MAC frame structure within another MAC frame structure (such as, the MAC frame structure of the beacon portion 702 or the MAC frame structure of each of the remote uplink portions 720, 722, 724.

Furthermore, it is noted that the use of the term communication burst or burst refers to the signal including a plurality of symbols transmitted within a given MAC frame structure or portion of a MAC frame structure. In preferred embodiments, the burst is modulated on a carrier waveform as an OFDM burst containing the appropriate OFDM symbols.

Thus, as can be seen, the MAC frame structure 700 includes multiple communication bursts, each including a preamble portion, a data portion and a diversity selection portion. It is noted that in other embodiments, a MAC frame structure may be formatted to transmit at least one burst, each burst including a preamble portion, a data portion and a diversity selection portion.

FIG. 21 illustrates an alternate burst structure to be used for a remote uplink portion 742 (e.g., one or more of the remote uplink portions 720, 722, 724) in which a diversity selection portion 740 is located in between the preamble portion 726 and the data portion 728, rather than as a postamble as illustrated in FIG. 20. Thus, as described herein the diversity selection portions of the various bursts of the MAC frame 700 may be located in different locations within each burst, e.g., within the preamble portion, between the preamble portion and the data portion, within the data portion, or as a postamble.

It is noted that the timing diagrams of FIGS. 20 and 21 are not necessarily drawn to scale such that the duration in time of the various portions may be varied according to the design and requirements of the system.

While the invention herein disclosed has been described by means of specific embodiments and applications thereof, numerous modifications and variations could be made thereto by those skilled in the art without departing from the scope of the invention set forth in the claims.

What is claimed is:

1. A method for use in communicating an orthogonal frequency division multiplexing (OFDM) signal, comprising the steps of:
receiving a burst with a system having L antenna branches and n radio frequency (RF) receivers, wherein the burst includes a diversity selection portion comprising one or more OFDM symbols that each have a frequency bin structure that includes both non-zero and zero OFDM frequency bin content;
taking a first set of measurements from a first of the L antenna branches on one or more of the non-zero OFDM frequency bins;
taking a second set of measurements from the first of the L antenna branches on one or more of the zero OFDM frequency bins; and
computing an estimate for carrier-to-noise-plus-interference ratio (CNIR) for at least one OFDM frequency bin of the first of the L antenna branches using the first and second set of measurements.

2. A method in accordance with claim 1, wherein the first and second set of measurements comprise power measurements.

3. A method in accordance with claim 1, wherein the first and second set of measurements comprise complex receiver fast Fourier transform (FFT) output values.

4. A method in accordance with claim 1, wherein the step of computing the estimate for the CNIR comprises the steps of:
estimating the CNIR for a respective OFDM frequency bin by:
summing respective ones of the first set of measurements within a window centered about the respective OFDM frequency bin to form a first sum;
summing respective ones of the second set of measurements within a window centered about the respective OFDM frequency bin to form a second sum;
dividing the first sum by the second sum to form a first quotient; and
subtracting 1 from the first quotient.

5. A method in accordance with claim 1 wherein the computing step comprises computing an estimate for carrier-to-noise-plus-interference ratio (CNIR) for each of the non-zero OFDM frequency bins and each of the zero OFDM frequency bins of the first of the L antenna branches using the first and second set of measurements.

6. A method in accordance with claim 1, further comprising the step of:
computing an average value over multiple bursts for the CNIR for the at least one OFDM frequency bin.

7. A method in accordance with claim 1, wherein the burst comprises a preamble portion and a data portion and the diversity selection portion follows the data portion.

8. A method in accordance with claim 1, wherein the one or more OFDM symbols comprise one or more OFDM symbols selected from a group consisting of: OFDM short symbols as defined in the IEEE 802.11a standard and OFDM short symbols as defined in the HiperLAN2 standard.

9. A method in accordance with claim 1, wherein the one or more OFDM symbols comprise OFDM symbols having alternating zero and non-zero frequency bin content throughout all subcarriers.

10. A method in accordance with claim 1, further comprising the steps of:
taking a third set of measurements from a second of the L antenna branches during one or more non-zero OFDM frequency bins;
taking a fourth set of measurements from the second of the L antenna branches during one or more zero OFDM frequency bins; and
computing an estimate for CNIR for at least one OFDM frequency bin of the second of the L antenna branches using the third and fourth set of measurements.

11. A method in accordance with claim 10, wherein the diversity selection portion further comprises one or more antenna branch probing portions, and the first and second set of measurements are taken by a first of the n RF receivers during a first antenna branch probing portion and the third and fourth set of measurements are taken by a second of the n RF receivers during the first antenna branch probing portion.

12. A method in accordance with claim 1, wherein:
the diversity selection portion further comprises one or more antenna branch probing portions;
and further comprising the step of,
computing estimates for CNIR for at least one OFDM frequency bin of additional ones of the L antenna branches by taking measurements from the additional ones of the L antenna branches n antenna branches at a time during different antenna branch probing portions.

13. A method for use in communicating an orthogonal frequency division multiplexing (OFDM) signal, comprising the steps of:
generating a burst having a preamble portion and a data portion;
adding a diversity selection portion to the burst, wherein the diversity selection portion includes one or more OFDM symbols that each have a frequency bin structure that includes both non-zero and zero OFDM frequency bin content; and
transmitting the burst including the diversity selection portion within a frame structure.

14. A method in accordance with claim 13, wherein the one or more OFDM symbols comprise one or more OFDM symbols selected from a group consisting of: OFDM short symbols as defined in the IEEE 802.11a standard and OFDM short symbols as defined in the HiperLAN2 standard.

15. A method in accordance with claim 13, wherein the one or more OFDM symbols comprise OFDM symbols having alternating zero and non-zero frequency bin content throughout all subcarriers.

16. A method in accordance with claim 13, wherein the diversity selection portion further comprises one or more antenna branch probing portions.

17. A method in accordance with claim 16, wherein the diversity selection portion further comprises one or more switching time intervals with one of the switching time intervals being located between two antenna branch probing portions.

18. A method in accordance with claim 13, wherein the preamble portion and the data portion are defined in accordance with the IEEE 802.11a standard.

19. A method in accordance with claim 13, wherein the preamble portion and the data portion are defined in accordance with the HiperLAN2 standard.

20. A method in accordance with claim 13, wherein the adding step comprises adding the diversity selection portion to the burst following the data portion.

21. A method in accordance with claim 13, wherein the adding step comprises adding the diversity selection portion to the burst positioned within the data portion.

22. A method in accordance with claim 13, wherein the adding step comprises adding the diversity selection portion to the burst following the preamble portion.

23. A method in accordance with claim 13, wherein the adding step comprises adding the diversity selection portion to the burst positioned within the preamble portion.

24. A communication burst embodied in an orthogonal frequency division multiplexing (OFDM) signal and transmitted within a frame structure, comprising:
a preamble portion including a plurality of OFDM symbols, the preamble portion including a coarse frequency estimation portion;
a data portion following the preamble portion and including a plurality of OFDM data symbols; and
a diversity selection portion comprising one or more antenna branch probing portions, the diversity selection portion occuring after the coarse frequency estimation portion of the preamble portion, wherein each of the one or more antenna branch probing portions includes one or more OFDM symbols.

25. A burst in accordance with claim 24, wherein each of the one or more OFDM symbols within each of the one or more antenna branch probing portions each have a frequency bin structure that includes both non-zero and zero OFDM frequency bin content.

26. A burst in accordance with claim 25, wherein each of the one or more OFDM symbols within each of the one or more antenna branch probing portions OFDM symbols selected from a group consisting of: OFDM short symbols as defined in the IEEE 802.11a standard and OFDM short symbols as defined in the HiperLAN2 standard.

27. A burst in accordance with claim 25, wherein each of the one or more OFDM symbols within each of the one or more antenna branch probing portions comprise OFDM symbols having alternating zero and non-zero frequency bin content throughout all subcarriers.

28. A burst in accordance with claim 24, wherein the diversity selection portion further comprises one or more switching time intervals with one of the switching time intervals being located between two antenna branch probing portions.

29. A burst in accordance with claim 24, wherein the preamble portion and the data portion are defined in accordance with a standard selected from a group consisting of: the IEEE 802.11a standard and the HiperLAN2 standard.

30. A burst in accordance with claim 24, wherein the diversity selection portion follows the data portion.

31. A burst in accordance with claim 24, wherein the diversity selection portion follows the preamble portion.

32. A burst in accordance with claim 24, wherein the diversity selection portion is positioned within the data portion.

33. A burst in accordance with claim 24, wherein the diversity selection portion is positioned within the preamble portion.

34. A burst in accordance with claim 24, wherein the diversity selection portion is configured for diversity antenna branch selection at a receiver receiving the communication burst based upon bin-by-bin measurements of the one or more OFDM symbols of the diversity selection portion.

35. A communication burst embodied in an orthogonal frequency division multiplexing (OFDM) signal and transmitted within a frame structure, comprising:
a preamble portion including a plurality of OFDM symbols;
a data portion following the preamble portion and including a plurality of OFDM data symbols; and
a diversity selection portion comprising one or more antenna branch probing portions, wherein each of the one or more antenna branch probing portions includes one or more OFDM symbols,
wherein the diversity selection portion is configured for diversity antenna branch selection at a receiver receiving the communication burst based upon bin-by-bin measurements of the one or more OFDM symbols of the diversity selection portion.

36. A burst in accordance with claim 35, wherein each of the one or more OFDM symbols within each of the one or more antenna branch probing portions each have a frequency bin structure that includes both non-zero and zero OFDM frequency bin content.

37. A burst in accordance with claim 39, wherein the diversity selection portion is located in a position within the communication burst selected from a group of positions consisting of: following the data portion, following the preamble portion, following a coarse frequency estimation portion of the preamble portion, within the data portion and within the preamble portion.

38. A medium access control (MAC) frame format embodied in an orthogonal frequency division multiplexing (OFDM) signal, comprising:
one or more communication bursts occupying different time portions of the frame format, each of the one or more communication bursts comprising:
a preamble portion including a plurality of OFDM symbols, the preamble portion including a coarse frequency estimation portion;
a data portion following the preamble portion and including a plurality of OFDM data symbols; and
a diversity selection portion comprising one or more antenna branch probing portions, the diversity selection portion occuring after the coarse frequency estimation portion of the preamble portion, wherein each of the one or more antenna branch probing portions includes one or more OFDM symbols.

39. A frame format in accordance with claim 38, wherein each of the one or more OFDM symbols within each of the one or more antenna branch probing portions of each of the one or more communication bursts each have a frequency bin structure that includes both non-zero and zero OFDM frequency bin content.

40. A frame format in accordance with claim 38, wherein the diversity selection portion of each of the one or more communication bursts is located in a position within the one or more communication bursts selected from a group of positions consisting of: following the data portion, following the preamble portion, within the data portion and within the preamble portion.

41. A method of performing diversity reception in radio frequency (RF) communications, comprising the steps of:
receiving a burst with a system having L antenna branches and n RF receivers, wherein L and n are variables and the burst includes a preamble portion, a data portion and a diversity selection portion, the diversity selection portion including one or more antenna branch probing portions, wherein each of the one or more antenna branch probing portions includes one or more OFDM symbols; and
taking measurements from n of the L antenna branches during one of the antenna branch probing portions.

42. A method in accordance with claim 41, wherein each of the one or more OFDM symbols within each of the one or more antenna probing portions each have a frequency bin structure that includes both non-zero and zero OFDM frequency bin content.

43. A method in accordance with claim 41, further comprising the step of:
taking measurements from a remainder of the L antenna branches by taking measurements from n antenna branches at a time during different antenna branch probing portions.

44. A method in accordance with claim 41, wherein the diversity selection portion further comprises one or more switching time intervals with one of the switching time intervals being located between two antenna branch probing portions, the method further comprising the step of:
switching to a different set of n of the L antenna branches during the one of the switching time intervals.

45. A method of performing diversity antenna selection, comprising the steps of:
taking measurements from L different antenna branches n antenna branches at a time; and
using the measurements to identify a group of n of the L different antenna branches that minimizes an approximate bit error probability of a subsequent signal that will eventually be constructed from sub-carriers that are each received by any one of the n antenna branches in the identified group of n antenna branches.

46. A method in accordance with claim 45, wherein the measurements comprise power measurements corresponding to each of K sub-carriers.

47. A method in accordance with claim 46, wherein the K sub-carriers form an orthogonal frequency division multiplexing (OFDM) signal.

48. A method in accordance with claim 46, wherein the step of using the measurements to identify a group of n of the L different antenna branches further comprises the step of:
computing an approximate bit error probability for each of the K sub-carriers for each of the L antenna branches n antenna branches at a time.

49. A method in accordance with claim 48, wherein the step of using the measurements to identify a group of n of the L different antenna branches further comprises the steps of:
forming different groupings of n antenna branches from among the L different antenna branches; and
for each different grouping of n antenna branches, selecting a minimum one of the approximate bit error probabilities for each one of the K sub-carriers.

50. A method in accordance with claim 49, wherein the step of using the measurements to identify a group of n of the L different antenna branches further comprises the step of:
for each different grouping of n antenna branches, summing the minimum ones of the approximate bit error probabilities that were selected for each one of the K sub-carriers.

51. A method in accordance with claim 50, wherein the step of using the measurements to identify a group of n of the L different antenna branches further comprises the steps of:
determining which sum of the minimum ones of the approximate bit error probabilities has a smallest value; and
selecting the grouping of n antenna branches that produced the sum of the minimum ones of the approximate bit error probabilities having the smallest value.

52. A method in accordance with claim 48, wherein the step of computing an approximate bit error probability for each of the K sub-carriers for each of the L antenna branches n antenna branches at a time further comprises the step of:
computing a detection statistic Λ_{k,l} for each of the K sub-carriers for each of the L antenna branches n antenna branches at a time based on the power measurements.

53. A method in accordance with claim 52, wherein the step of computing an approximate bit error probability for each of the K sub-carriers for each of the L antenna branches n antenna branches at a time further comprises the step of:
approximating a Q-function for each of the K sub-carriers for each of the L antenna branches n antenna branches at a time with a corresponding detection statistic comprising an argument thereof.

54. A method in accordance with claim 45, wherein the step of taking measurements from L different antenna branches n antenna branches at a time comprises the steps of:
receiving a burst that includes a diversity selection portion comprising one or more antenna branch probing portions; and
taking measurements from n antenna branches during one of the antenna branch probing portions.

55. A method in accordance with claim 54, wherein the step taking measurements from n antenna branches during one of the antenna branch probing portions comprises the step of:
taking measurements from each one of the n antenna branches with a separate one of n radio frequency receivers.

56. A method in accordance with claim 52, wherein the detection statistic is based upon a carrier-to-noise+interference ratio (CNIR) corresponding to each of the K sub-carriers.

57. A method in accordance with claim 45, further comprising the step of:
constructing an output signal from sub-carriers that are each received by any one of the n antenna branches in the identified group of n antenna branches.

58. A method in accordance with claim 57, wherein the step of constructing an output signal from sub-carriers comprises the steps of:
computing a detection statistic Λ_{k,l} for each of K sub-carriers for each of the n antenna branches in the identified group of n antenna branches; and
comparing the detection statistics for each of the K sub-carriers for each of the n antenna branches in the identified group of n antenna branches with the detection statistics for each of the respective K sub-carriers for each of the other n antenna branches in the identified group of n antenna branches.

59. A method in accordance with claim 58, wherein the step of constructing an output signal from sub-carriers further comprises the step of:
based on results of the comparing step, selecting sub-carriers from one or more of the n antenna branches in the identified group of n antenna branches to form the output signal.

60. A method in accordance with claim 45, further comprising the step of:
using the measurements to determine an estimate of the carrier-to-noise+interference ratio (CNIR) for at least one frequency bin of one of the L antenna branches.

61. A diversity antenna selection module, comprising:
means for taking measurements from L different antenna branches n antenna branches at a time; and
means for using the measurements to identify a group of n of the L different antenna branches that minimizes an approximate bit error probability of a subsequent signal that will eventually be constructed from sub-carriers that are each received by any one of the n antenna branches in the identified group of n antenna branches.

62. An apparatus that includes a diversity antenna selection module, wherein the diversity antenna selection module comprises:
a first computation stage configured to compute an approximate bit error probability for each of K sub-carriers of an OFDM signal received for each of L different antenna branches n antenna branches at a time; and
a second computation stage configured to process the approximate bit error probabilities to identify a group of n of the L different antenna branches that minimizes an approximate bit error probability of subsequent OFDM signals that will eventually be constructed from sub-carriers that are each received by any one of the n antenna branches in the identified group of n antenna branches.

63. An apparatus in accordance with claim 62, wherein the second computation stage further comprises:
a multiplexer configured to form different groupings of n antenna branches from among the L different antenna branches; and
a minimum function stage configured to select a minimum one of the approximate bit error probabilities for each one of the K sub-carriers of the OFDM signal received for each different grouping of n antenna branches.

64. An apparatus in accordance with claim 63, wherein the second computation stage further comprises:
a summation stage configured to sum the minimum ones of the approximate bit error probabilities that were selected for each one of the K sub-carriers of the OFDM signal received for each different grouping of n antenna branches.

65. An apparatus in accordance with claim 64, wherein the second computation stage further comprises:
a minimum metric selection stage configured to determine which sum of the minimum ones of the approximate bit error probabilities has a smallest value; and
a diversity antenna decision stage configured to select the grouping of n antenna branches that produced the sum of the minimum ones of the approximate bit error probabilities having the smallest value.

66. An apparatus in accordance with claim 62, wherein the first computation stage further comprises:
n detection statistic stages each configured to compute a detection statistic Λ_{k,l} for each of K sub-carriers.

67. An apparatus in accordance with claim 66, wherein the detection statistic is based upon a carrier-to-noise+interference ratio (CNIR) corresponding to each of the K sub-carriers of the OFDM signal received for each of L different antenna branches n antenna branches at a time.

68. An apparatus in accordance with claim 66, wherein the detection statistic stages determine an estimate of the carrier-to-noise+interference ratio (CNIR) corresponding to at least one of the K sub-carriers of the OFDM signal received for each of L different antenna branches n antenna branches at a time.

69. An apparatus in accordance with claim 66, wherein the first computation stage further comprises:
n Q-function stages each configured to process detection statistics.

70. An apparatus in accordance with claim 61, further comprising:
n radio frequency receivers coupled to the diversity antenna selection module.

71. An apparatus in accordance with claim 61, further comprising:
an antenna selection stage configured to allow each of n different radio frequency receivers to be coupled to any one of the L different antenna branches.

72. An apparatus in accordance with claim 62, further comprising:
a diversity antenna structure having L different antenna branches.

73. An apparatus in accordance with claim 62, further comprising:
a sub-carrier selection diversity module configured to construct an output signal from sub-carriers that are each received by any one of the n antenna branches in the identified group of n antenna branches.

74. An apparatus in accordance with claim 73, wherein the sub-carrier selection diversity module comprises:
n detection statistic stages each configured to compute a detection statistic Λ_{k,l} for each of K sub-carriers of the other OFDM signal received for one of the n antenna branches in the identified group of n antenna branches; and
a comparator configured to compare the detection statistics for each of the K sub-carriers of the subsequent OFDM signals received for each of the n antenna branches in the identified group of n antenna branches with the detection statistics for each of the respective K sub-carriers of the subsequent OFDM signals received for each of the other n antenna branches in the identified group of n antenna branches.

75. An apparatus in accordance with claim 74, wherein the sub-carrier selection diversity module further comprises:
a multiplexer configured to select sub-carriers from one or more of the n antenna branches in the identified group of n antenna branches based on data generated by the comparator to form the output signal.
